(19) United States
(12) Patent Application Publication
(10) Pub. No.: US 2024/0047822 A1
(43) Pub. Date: Feb. 8, 2024

(54) SEPARATORS, ADDITIVES, ENERGY STORAGE DEVICES AND ELECTRODES INCLUDING THEM, AND METHODS OF THEIR MANUFACTURE

(71) Applicant: Alsym Energy, Inc., Woburn, MA (US)

(72) Inventors: Daniel Anthony Evans, Melrose, MA (US); Christopher Ryan Marsh, Waltham, MA (US); Blayne Phillips, Wilmington, MA (US); Rahul Mukherjee, Winchester, MA (US); Kripa Kiran Varanasi, Lexington, MA (US)

(73) Assignee: Alsym Energy, Inc., Woburn, MA (US)

(21) Appl. No.: 18/230,297

(22) Filed: Aug. 4, 2023

Related U.S. Application Data
(60) Provisional application No. 63/395,748, filed on Aug. 5, 2022.

(51) Int. Cl. H01M 50/446; H01M 50/491; H01M 50/403; H01M 50/497

(52) U.S. Cl. CPC H01M 50/446; H01M 50/491; H01M 50/403; H01M 50/497

(57) ABSTRACT

Separators and additives (e.g., electrode additives) for use in energy storage devices are disclosed. In certain embodiments, a separator includes inorganic particles. In certain embodiments, an additive includes inorganic particles. The additive may be used in an electrode, such as a cathode or anode in a battery. The inorganic particles (whether included in a separator or used in (e.g., as) an additive, for example for an electrode) may be functional inorganic particles that promote battery performance and/or safety. For example, the functional inorganic particles may act to reduce or eliminate side reactions or mitigate the effects of side reactions during electrochemical cycling of an energy storage device in which they are included (e.g., discharge and/or charge of a battery). As another example, the functional inorganic particles may additionally or alternatively promote ionic conductivity.

### CROSS-REFERENCE TO RELATED APPLICATIONS

This application claims priority to U.S. Provisional Application No. 63/395,748 filed on Aug. 5, 2022, the entirety of which is incorporated herein by reference.

### TECHNICAL FIELD

This disclosure relates generally to separators, electrode additives and their methods of manufacture, generally for use in energy storage devices.

### BACKGROUND

Energy storage devices, such as electrochemical cells, generally include multiple components, such as electrodes, an electrolyte, and a separator. Each of these components can contribute to performance of the energy storage device as a whole. Moreover, together these components generally provide a complex electrochemical environment. Complex electrochemical environments often result in undesirable side reactions that act to reduce battery performance and/or safety. There is a need, therefore, for separators and/or electrode compositions that promote favorable electrochemical reactions in energy storage devices (e.g., during charge and/or discharge of a battery).

### SUMMARY

Described herein are, inter alia, separators and additives (e.g., electrode additives) for use in energy storage devices. In certain embodiments, a separator includes inorganic particles. In certain embodiments, an additive includes inorganic particles. The additive may be used in an electrode, such as a cathode or anode in a battery. The inorganic particles (whether included in a separator or used in (e.g., as) an additive, for example for an electrode) may be functional inorganic particles that promote battery performance and/or safety. For example, the functional inorganic particles may act to reduce or eliminate side reactions or mitigate the effects of side reactions during electrochemical cycling of an energy storage device in which they are included (e.g., discharge and/or charge of a battery). As another example, the functional inorganic particles may additionally or alternatively promote ionic conductivity. In certain embodiments, a separator and/or an additive includes one or more functional materials that each include one or more organic ligands, one or more non-metallic oxides, or a combination thereof. In certain embodiments, a separator includes partially reduced graphene oxide, partially reduced graphite oxide, or a combination thereof.

In some aspects, the present disclosure is directed to a separator for an energy storage device, the separator comprising inorganic particles and, optionally, one or more binders, wherein the one or more binders bind together the inorganic particles (e.g., of one type or of different types).

In some embodiments, the inorganic particles are functional inorganic particles. In some embodiments, the separator is a solid layer or semi-solid (e.g., gel or gelatinous) layer (e.g., surface layer). In some embodiments, the inorganic particles are at least 50 wt. % of the separator (e.g., at least 60 wt. %, at least 70 wt. %, at least 80 wt. % of the separator, at least 90 wt. %, or at least 95 wt. %).

In some embodiments, the inorganic particles comprise one or more elements selected from the group consisting of oxygen, hydrogen, sulfur, aluminum, silicon, and phosphorous [e.g., wherein the one or more elements are at least 10 wt. % (e.g., at least 20 wt. %, at least 30 wt. %, or at least 50 wt. %) of the inorganic particles] [e.g., wherein the one or more elements are no more than 80 wt. % (e.g., no more than 50 wt. %, no more than 30 wt. %, no more than 20 wt. %) of the inorganic particles]. In some embodiments, the inorganic particle comprise one or more metal atoms [e.g., wherein the one or more metal atoms are at least 10 wt. % (e.g., at least 20 wt. %, at least 30 wt. %, or at least 50 wt. %) of the inorganic particles] [e.g., wherein the one or more metal atoms are no more than 80 wt. % (e.g., no more than 50 wt. %, no more than 30 wt. %) of the inorganic particles]. In some embodiments, the one or more metal atoms are selected from the group consisting of aluminum, silicon, lithium, sodium, potassium, rubidium, cesium, beryllium, magnesium, calcium, strontium, barium, boron, gallium, indium, thallium, carbon, germanium, tin, lead, nitrogen, phosphorous, arsenic, antimony, bismuth, scandium, titanium, vanadium, chromium, manganese, iron, cobalt, nickel, copper, zinc, yttrium, zirconium, niobium, molybdenum, ruthenium, rhodium, palladium, silver, cadmium, hafnium, tantalum, tungsten, rhenium, osmium, iridium, platinum, gold, mercury, lanthanum, cerium, praseodymium, neodymium, samarium, europium, gadolinium, terbium, dysprosium, holmium, erbium, thulium, ytterbium, lutetium, actinium, thorium, protactinium, uranium, neptunium, and plutonium.

In some embodiments, the inorganic particles are porous. In some embodiments, the inorganic particles have microporosity, mesoporosity, macroporosity, or a combination thereof. In some embodiments, the inorganic particles comprise one or more pores having a size (e.g., diameter) of less than 2 nm (e.g., wherein each of the inorganic particles comprises one or more pores having a size of less than 2 nm). In some embodiments, the inorganic particles comprise one or more pores having a size (e.g., diameter) of at least 2 nm and no more than 50 nm (e.g., wherein each of the inorganic particles comprises one or more pores having a dimension of at least 2 nm and no more than 50 nm). In some embodiments, the inorganic particles comprise one or more pores having a size (e.g., diameter) of more than 50 nm (e.g., wherein each of the inorganic particles comprise one or more pores having a size of more than 50 nm). In some embodiments, each of the inorganic particles comprise one or more pores having a size (e.g., diameter) in a range of from 1 Å to 20 Å (e.g., from 1 Å to 10 Å, from 3 Å to 8 Å, from 4 Å to 5 Å) [e.g., from 1.5 Å (e.g., 1.56 Å) to 16.5 Å (e.g., 16.45 Å)]. In some embodiments, each of the inorganic particles comprises one or more pores that connect to form at least one channel through the inorganic particle. In some embodiments, the at least one channel for each of the inorganic particles are connected to form a channel system. In some embodiments, the channel system is a 1-dimensional, 2-dimensional, or 3-dimensional channel system. In some embodiments, the channel system extends throughout the separator [e.g., from a first surface of the separator to a second surface of the separator that opposes the first surface (e.g., from an anode side to a cathode side)].

In some embodiments, the inorganic particles comprise one or more cage structures. In some embodiments, at least one of the one or more cage structures is disposed at an intersection of pores of the inorganic particles. In some embodiments, each of the one or more cage structures has a size (e.g., diameter) in a range of from 1 Å to 20 Å (e.g., from 1 Å to 10 Å, from 5 Å to 15 Å, from 10 Å to 12 Å, from 3 Å to 8 Å, from 5 Å to 7 Å or from 6 Å to 7 Å). In some embodiments, at least one of the one or more cage structures is disposed in a 1-dimensional pore. In some embodiments, one or more species are disposed in (e.g., adsorbed in) the one or more cage structures.

In some embodiments, one or more species are disposed in (e.g., adsorbed in) one or more pores of the inorganic particles [e.g., on a surface of the one or more pores (e.g., an internal surface, near an opening, or both)] (e.g., wherein the one or more species are not covalently bonded to the one or more pores). In some embodiments, the one or more species comprise a member selected from the group consisting of olefinic hydrocarbons, paraffinic hydrocarbons, naphthenic hydrocarbons, and aromatic hydrocarbons. In some embodiments, the one or more species comprise water. In some embodiments, the one or more species comprise one or more gas species. In some embodiments, the one or more gas species are selected from the group consisting of hydrogen, oxygen, carbon oxides, nitrogen, argon, hydrogen disulfide, ammonia, nitric oxide, nitrogen oxides and sulfur oxides. In some embodiments, the one or more species comprise one or more cationic species. In some embodiments, the one or more cationic species are each a cationic form of an element selected from the group consisting of lithium, sodium, potassium, rubidium, cesium, beryllium, magnesium, calcium, strontium, barium, boron, aluminum, gallium, indium, thallium, carbon, germanium, tin, lead, nitrogen, phosphorous, arsenic, antimony, bismuth, scandium, titanium, vanadium, chromium, manganese, iron, cobalt, nickel, copper, zinc, yttrium, zirconium, niobium, molybdenum, ruthenium, rhodium, palladium, silver, cadmium, hafnium, tantalum, tungsten, rhenium, osmium, iridium, platinum, gold, mercury, lanthanum, cerium, praseodymium, neodymium, samarium, europium, gadolinium, terbium, dysprosium, holmium, erbium, thulium, ytterbium, lutetium, actinium, thorium, protactinium, uranium, neptunium, and plutonium. In some embodiments, the one or more species comprise one or more anionic species. In some embodiments, the one or more anionic species are selected from the group consisting of hydroxides, alkoxides, peroxides, superoxides, nitrates, nitrites, sulfates, sulfites, phosphates, phosphides, fluorides, chlorides, bromides, iodides, chlorates, bromates, iodates, polyoxymetalates, and combinations thereof.

In some embodiments, the inorganic particles have a surface area of at least 10 m²/g (e.g., at least 100 m²/g, at least 250 m²/g, at least 300 m²/g, at least 500 m²/g, or at least 700 m²/g).

In some embodiments, the inorganic particles comprises one or more particles having a composition of M_{y}AlₓSi₁₋ₓO₂·zH₂O, where M is a metal. In some embodiments, x is in a range of 0 to 0.5 (e.g., 0 to 0.1 or from 0.01 to 0.5) and y is in a range of 0 to 0.5 (e.g., 0 to 0.1). In some embodiments, x is in a range of from 0.5 to 1 and y is in a range of 0 to 1. In some embodiments, z is in a range of 0 to 10,000.

In some embodiments, polar sites are disposed on a surface of the inorganic particles [e.g., an internal surface (e.g., of a pore)]. In some embodiments, the inorganic particles are crystalline or amorphous. In some embodiments, the inorganic particles have an average particle size (d₅₀ diameter) in a range of from 100 nm to 30 μm. In some embodiments, the inorganic particles comprise one or more particles having a spherical shape, one or more particles having a rod shape, one or more particles having a needle shape, one or more particles having a flake shape, one or more particles having a platelet shape, one or more particles having a cube shape, one or more particles having a disc shape, one or more particles having a tube shape, or a combination thereof.

In some embodiments, the inorganic particles have been prepared by a crystallization reaction of chemical precursors at 30-250° C. for no more than 30 days. In some embodiments, the reaction proceeded under stirring. In some embodiments, the crystallization reaction is performed without stirring. In some embodiments, the chemical precursors comprise a silica source and an alumina source. In some embodiments, the chemical precursors comprise a mineralizing agent, acidic or basic media, a templating agent, a structure directing agent (SDA), or a combination thereof.

In some embodiments, the one or more binders are no more than 50 wt. % (e.g., no more than 40 wt. %, no more than 30 wt. %, no more than 20 wt. %, no more than 10 wt. %, no more than 5 wt. %, or no more than 1 wt. %) of the separator. In some embodiments, the one or more binders are selected from the group consisting of polyvinylidene fluoride (PVDF), polytetrafluoroethylene (PTFE), polyvinyl alcohol, polyvinylpyrrolidone (PVP), polyacrylic acid (PAA), polyurethane (PU), polyvinyl acetate, polyvinyl chloride (PVC), carboxymethyl cellulose (CMC), hydroxypropyl cellulose (HPC), hydroxyethyl cellulose (HEC), and styrene butadiene rubber (SBR). In some embodiments, at least one of the one or more binders comprises one or more binder additives. In some embodiments, the one or more binder additives comprise one or more members selected from the group consisting of pH adjusters, pH buffers, rheological modifiers, de-foamers, anti-foamers, adhesion promoters, and leveling agents.

In some embodiments, the separator further comprises a conductive polymer. In some embodiments, the conductive polymer is no more than 80 wt. % (e.g., no more than 50 wt. %) of the separator. In some embodiments, the conductive polymer is selected from the group consisting of polyaniline, polyacetylene, polyphenylene vinylene, polypyrrole, polythiophene, polyphenylene sulfide, polyfluorenes, polypyrenes, polyazulenes, polynapthalenes, poly(p-phenylene vinylene), poly(p-phenylene sulfide), and PEDOT.

In some embodiments, the separator has been in situ or ex situ coated on an electrode (e.g., an anode, a cathode, or both) (e.g., by wet chemical reaction, physical vapor deposition, chemical vapor deposition, atomic layer deposition, sintering, pressing, hot pressing, extrusion, die casting, slot-die coating, doctor-blade coating, dip coating, or a combination thereof) (e.g., by a liquid coating method). In some embodiments, the separator has further been calendared (e.g., thereby increasing adhesive strength, layer uniformity, or both), annealed, or both.

In some embodiments, the separator has a thickness in a range of from 5 μm to 500 μm. In some embodiments, the separator is a free-standing film.

The separator may be included in an energy storage device along with two electrodes, wherein the separator is disposed between the two electrodes such that the separator prevents direct physical contact of the two electrodes. In some embodiments, the energy storage device further comprises a second separator as disclosed herein, wherein the second separator is disposed between the two electrodes such that the second separator prevents direct physical contact of the two electrodes.

In some embodiments, the energy storage device further comprises an electrolyte disposed between the two electrodes [e.g., a solid or liquid (e.g., aqueous) electrolyte] (e.g., an ion conducting matrix). In some embodiments, the electrolyte is a solid polymer electrolyte selected from the group consisting of (i) polymers that comprise repeat units of one or more of an ethylene oxide, a propylene oxide, analizarin, an alginate, a quinones, a hydroxyquinones, a hydroxyquinoline, silicon, a silicate, and asulfone, (ii) cellulosic, natural or modified natural polymers, and (iii) synthetic fluorinated polymers (e.g., polyvinylidene fluoride (PVDF) and polytetrafluoroethylene (PTFE)). In some embodiments, the electrolyte comprises one or more materials each having a stoichiometry of M1¹⁺ₓN1ₚ or M1²⁺ₓN1ₚ or M1³⁺ₓN1ₚ or M1⁴⁺ₓN1ₚ or M1¹⁺ₓN1ₚN2_{q} or M1²⁺ₓN1ₚN2_{q} or M1³⁺ₓN1ₚN2_{q} or M1⁴⁺ₓN1ₚN2_{q} or M1¹⁺ₓM2²⁺_{y}N1ₚ or M1¹⁺ₓM2³⁺_{y}N1ₚ or M1¹⁺ₓM2⁴⁺_{y}N1ₚ or M1²⁺ₓM2³⁺_{y}N1ₚ or M1²⁺ₓM2⁴⁺_{y}N1ₚ or M1³⁺ₓM2⁴⁺_{y}N1ₚ or M1¹⁺ₓM2²⁺_{y}N1ₚN2_{q} or M1¹⁺ₓM2³⁺_{y}N1ₚN2_{q} or M1¹⁺ₓM2⁴⁺_{y}N1ₚN2_{q} or M1²⁺ₓM2³⁺_{y}N1ₚN2_{q} or M1²⁺ₓM2⁴⁺_{y}N1ₚN2_{q} or M1³⁺ₓM2⁴⁺_{y}N1ₚN2_{q} or M1¹⁺ₓM2²⁺_{y}M3³⁺_{z}N1p or M1¹⁺ₓM2²⁺_{y}M3⁴⁺_{z}N1ₚ or M1²⁺ₓM2³⁺_{y}M3⁴⁺_{z}N1ₚ or M1¹⁺ₓM2²⁺_{y}M3³⁺_{z}N1ₚN2_{q} or M1¹⁺ₓM2²⁺_{y}M3⁴⁺_{z}N1ₚN2_{q} or M1²⁺ₓM2³⁺_{y}M3⁴⁺_{z}N1ₚN2_{q} or M1¹⁺ₓM2²⁺_{y}M3³⁺_{z}M4⁴⁺ₛN1ₚ or M1¹⁺ₓM2²⁺_{y}M3³⁺_{z}M4⁴⁺ₛN1ₚ N2_{q}, wherein each M (e.g., M1, M2, M3, M4) is a monovalent or multivalent atom and each N (e.g., N1, N2) is a functional group (e.g., selected from the group consisting of a hydroxide, an alkoxide, a peroxide, a superoxide, a nitrate, a nitrite, a sulfate, a sulfite, a sulfide, a carbonate, a phosphate, a phosphate, a phosphide and a halide). In some embodiments, the electrolyte comprises one or more of: a salt, an acid, and a base. In some embodiments, the electrolyte: (i) comprises the salt, wherein the salt is selected from the group consisting of oxide, hydroxide, alkoxide, peroxide, superoxide, nitrate, nitrite, sulfate, sulfite, sulfide, carbonate, carbide, phosphate, phosphate, phosphide and halide salts of one or more of sodium, potassium, calcium, barium, cesium, scandium, cadmium, magnesium, iron, manganese, lithium, zinc, zirconium, niobium, yttrium, molybdenum, hafnium, osmium, nickel, cobalt, germanium, beryllium, mercury, tungsten, platinum, rubidium, ruthenium, rhodium, palladium, antimony, tellurium, bismuth, arsenic, lead, lanthanum, europium, gadolinium, cerium, tin, chromium, vanadium, titanium, aluminum, tantalum, gallium, indium, silver, gold, and copper; (ii) comprises the acid, wherein the acid is selected from the group consisting of phosphoric acid, nitric acid, sulfuric acid, hydrochloric acid, sulfurous acid, triflic acid, hydrofluoric acid, peracetic acid, boric acid, uric acid, citric acid, hydroiodic acid, carbonic acid, oxalic acid, bromic acid, chromic acid, formic acid, ascorbic acid, and acetic acid; (iii) comprises the base, wherein the base is selected from the group consisting of hydroxides of sodium, potassium, calcium, magnesium, manganese, lithium, zinc, zirconium, cerium, tin, titanium, aluminum, ammonium, iron, indium, molybdenum, nickel, platinum, palladium, ruthenium, silver, vanadium, and copper; or (iv) any combination of (i), (ii), and (iii). In some embodiments, the electrolyte comprises one or more ceramics selected from the group consisting of aluminum oxide, ammonium antimony tungsten oxide, barium titanate, strontium titanate, bismuth strontium calcium copper oxide, boron oxide, boron nitride, ferrites, lead zirconate titanate, magnesium diboride, porcelain, sialon, silicon, silicates, carbide, nitride, titanium carbide, uranium oxide, yttrium barium copper oxide, zinc oxide, cesium oxide, cerium oxide, zirconium oxide, vanadium oxide, tin oxide, iron oxide, tungsten chloride oxide, beryllium oxide, bismuth oxide, lithium oxide, lead oxide, manganese oxide, magnesium oxide, nickel oxide, titanium oxide, cadmium oxide, copper oxide, indium oxide, and silicon oxide. In some embodiments, the electrolyte is a free-standing film or has been applied to the separator and/or to at least one of the two electrodes.

In some embodiments, at least one of the two electrodes comprises an electroactive material comprising an oxide, a suboxide, a sulfide, an oxysulfide, a phosphate, a phosphide, a carbide, or an elemental form of an element selected from the group consisting of silicon, vanadium, niobium, molybdenum, rhenium, tantalum, tungsten, bismuth, titanium, tin, antimony, manganese, nickel, aluminum, lithium, sodium, potassium, calcium, zinc, cobalt, chromium, indium, lanthanum, cerium, strontium, iron, and combinations thereof. In some embodiments, the electroactive material has been modified (e.g., doped) with one or more elements. In some embodiments, the one or more elements comprise one or more members selected from the group consisting of hydrogen, lithium, boron, carbon, nitrogen, iodine, phosphorous, oxygen, sulfur, sodium, magnesium, aluminum, silicon, potassium, calcium, titanium, vanadium, chromium, manganese, iron, cobalt, nickel, copper, zinc, gallium, germanium, rubidium, strontium, zirconium, niobium, molybdenum, ruthenium, silver, cadmium, indium, tin, antimony, arsenic, lanthanum, cerium, neodymium, tantalum, tungsten, tellurium, rhenium, platinum, gold, lead, and bismuth. In some embodiments, the one or more elements are less than 50 wt. % (e.g., no more than 40 wt. %, no more than 30 wt. %, no more than 20 wt. %, no more than 10 wt. %, no more than 5 wt. %, or no more than 1 wt. %) of the electroactive material.

In some embodiments, wherein one of the two electrodes is disposed on a substrate. In some embodiments, the substrate is a carbon structure or a metallic structure. In some embodiments, the substrate is a foam, a paper, an aerogel, a foil, a fiber, a nanostructure (e.g., nanoparticle), a sheet, a mesh, or a stock. In some embodiments, the substrate comprises a polymeric material. In some embodiments, the polymeric material is selected from the group consisting of polyvinylidene fluoride (PVDF), polytetrafluoroethylene (PTFE), polyvinyl alcohol, polyvinylpyrrolidone (PVP), polyvinyl acetate, polyvinyl chloride (PVC), carboxymethyl cellulose (CMC), hydroxypropyl cellulose (HPC), hydroxyethyl cellulose (HEC), styrene butadiene rubber (SBR), polyaniline (PANI), polypyrrole (PPyr), polystyrene (PS), and polythiophene (PT).

In some embodiments, at least one of the two electrodes comprises a binder selected from the group consisting of polyvinylidene fluoride (PVDF), polytetrafluoroethylene (PTFE), polyvinyl alcohol, polyvinylpyrrolidone (PVP), polyvinyl acetate, polyacrylic acid (PAA), polyvinyl chloride (PVC), carboxymethyl cellulose (CMC), hydroxypropyl cellulose (HPC), hydroxyethyl cellulose (HEC), styrene butadiene rubber (SBR), and copolymers thereof. In some embodiments, at least one of the two electrodes comprises a conductive additive selected from the group consisting of carbon black, acetylene black, carbon fibers, carbon nanotubes, graphene, graphite, fullerenes, carbon aerogels, metal flakes, metal fibers, or metal particles, and conductive polymers. In some embodiments, the conductive additive is a conductive polymer that is selected from the group consisting of polyaniline, polyacetylene, polyphenylene vinylene, polypyrrole, polythiophene, polyphenylene sulfide, polyfluorenes, polypyrenes, polyazulenes, polynapthalenes, poly(p-phenylene vinylene), poly(p-phenylene sulfide), and PEDOT.

In some embodiments, at least one of the two electrodes comprises an additive material, the additive selected from the group consisting of metals, oxides, suboxides, hydroxides, oxide hydroxides, oxychlorides, sulfides, oxysulfides, oxynitrates, carbonates, nitrides, phosphates, phosphites, carbides, and polymers, containing one or more members selected from the group consisting of hydrogen, lithium, boron, carbon, nitrogen, oxygen, sulfur, sodium, magnesium, aluminum, silicon, potassium, calcium, titanium, vanadium, chromium, manganese, iron, cobalt, nickel, copper, zinc, gallium, germanium, rubidium, strontium, zirconium, niobium, molybdenum, ruthenium, silver, cadmium, indium, tin, lanthanum, cerium, neodymium, tantalum, tungsten, rhenium, platinum, gold, lead, and bismuth.

In some embodiments, the energy storage device is a primary battery, a secondary battery, a secondary battery, a fuel cell, or a capacitor. In some embodiments, the energy storage device is an aqueous battery (e.g., an aqueous secondary battery or an aqueous primary battery).

In some aspects, the present disclosure is directed to a method of making inorganic particles for use in a separator or as an additive in an energy storage device, the method comprising performing a crystallization reaction of chemical precursors at 30-250° C. for no more than 30 days. In some embodiments, the method comprises stirring the chemical precursors during the crystallization reaction. In some embodiments, the crystallization reaction is performed without stirring. In some embodiments, the chemical precursors comprise a silica source and an alumina source. In some embodiments, the chemical precursors further comprise a mineralizing agent, acidic or basic media, a templating agent, a structure directing agent (SDA), or a combination thereof.

In some aspects, the present disclosure is directed to a method of operating an energy storage device, the method comprising: providing an energy storage device as disclosed herein; and trapping gas in pores of the inorganic particles during charge and/or discharge of the energy storage device.

In some aspects, the present disclosure is directed to a method of operating and/or preparing an energy storage device, the method comprising: providing the energy storage device, wherein the energy storage device comprises inorganic particles that comprise one or more members selected from the group consisting of silicates, phosphates, sulfates, oxides, hydrides, and combinations thereof (e.g., one or more silicates and/or one or more phosphates) [e.g., in a stable (e.g., salt) and/or ionic (e.g., anionic) form]; reacting the one or more members with one or more species (e.g., one or more moieties thereof) in the energy storage device to form one or more reaction products; and passivating a surface of a material in the energy storage device with the one or more reaction products (e.g., thereby inhibiting one or more undesired side reactions). In some embodiments, the reacting occurs during electrochemical cycling of the energy storage device (e.g., during charge and/or discharge) (e.g., wherein the energy storage device is a primary or secondary battery). In some embodiments, the reacting occurs before completing assembly of the energy storage device (e.g., occurs during a preconditioning process for the energy storage device). In some embodiments, the one or more reaction products comprise a polymeric species (e.g., a polysilicate and/or a polyphosphate). In some embodiments, the method comprises reacting the one or more reaction products with the surface of the material. In some embodiments, reacting the one or more members comprises dissolving at least a portion of the inorganic particles (e.g., into an electrolyte of the energy storage device). In some embodiments, passivating the surface of the material comprises precipitating a polysilicate and/or polyphosphate onto the surface. In some embodiments, at least a portion of the inorganic particles are comprised in a separator of the energy storage device. In some embodiments, at least a portion of the inorganic particles are comprised in an additive that is comprised in an electrode of the energy storage device (e.g., wherein the electrode is an anode or a cathode or wherein the additive is comprised in both an anode and a cathode). In some embodiments, the material is metallic. In some embodiments, the material is an electroactive material.

In some aspects, the present disclosure is directed to an energy storage device comprising inorganic particles comprising one or more members selected from the group consisting of silicates, phosphates, sulfates, oxides, hydrides, and combinations thereof (e.g., one or more silicates and/or one or more phosphates [e.g., in a stable (e.g., salt) and/or ionic (e.g., anionic) form] and a material comprising a passivated surface passivated with one or more species derived from the one or more members (e.g., the one or more silicates and/or one or more phosphates) (e.g., that is/are reaction products of the one or more members) [e.g., wherein the one or more species comprise one or more polymeric species (e.g., one or more polysilicates and/or one or more polyphosphates)] (e.g., wherein the inorganic particles are comprised in a separator and/or an electrode).

In some aspects, the present disclosure is directed to an additive (e.g., electrode additive) for an energy storage device, the additive comprising inorganic particles (e.g., of one type or of different types).

In some embodiments, the inorganic particles are functional inorganic particles. In some embodiments, the inorganic particles comprise one or more elements selected from the group consisting of oxygen, hydrogen, sulfur, aluminum, silicon, and phosphorous [e.g., wherein the one or more elements are at least 10 wt. % (e.g., at least 20 wt. %, at least 30 wt. %, or at least 50 wt. %) of the inorganic particles] [e.g., wherein the one or more elements are no more than 80 wt. % (e.g., no more than 50 wt. %, no more than 30 wt. %, no more than 20 wt. %) of the inorganic particles]. In some embodiments, the inorganic particle comprise one or more metal atoms [e.g., wherein the one or more elements are at least 10 wt. % (e.g., at least 20 wt. %, at least 30 wt. %, or at least 50 wt. %) of the inorganic particles] [e.g., wherein the one or more elements are no more than 80 wt. % (e.g., no more than 50 wt. %, no more than 30 wt. %, no more than 50 wt. %) of the inorganic particles]. In some embodiments, the one or more metal atoms are selected from the group consisting of aluminum, silicon, lithium, sodium, potassium, rubidium, cesium, beryllium, magnesium, calcium, strontium, barium, boron, gallium, indium, thallium, carbon, germanium, tin, lead, nitrogen, phosphorous, arsenic, antimony, bismuth, scandium, titanium, vanadium, chromium, manganese, iron, cobalt, nickel, copper, zinc, yttrium, zirconium, niobium, molybdenum, ruthenium, rhodium, palladium, silver, cadmium, hafnium, tantalum, tungsten, rhenium, osmium, iridium, platinum, gold, mercury, lanthanum, cerium, praseodymium, neodymium, samarium, europium, gadolinium, terbium, dysprosium, holmium, erbium, thulium, ytterbium, lutetium, actinium, thorium, protactinium, uranium, neptunium, and plutonium.

In some embodiments, the inorganic particles are porous. In some embodiments, the inorganic particles have microporosity, mesoporosity, macroporosity, or a combination thereof. In some embodiments, the inorganic particles comprise one or more pores having a size (e.g., diameter) of less than 2 nm (e.g., wherein each of the inorganic particles comprises one or more pores having a size of less than 2 nm). In some embodiments, the inorganic particles comprise one or more pores having a size (e.g., diameter) of at least 2 nm and no more than 50 nm (e.g., wherein each of the inorganic particles comprises one or more pores having a dimension of at least 2 nm and no more than 50 nm). In some embodiments, the inorganic particles comprise one or more pores having a size (e.g., diameter) of more than 50 nm (e.g., wherein each of the inorganic particles comprise one or more pores having a size of more than 50 nm). In some embodiments, each of the inorganic particles comprise one or more pores having a size (e.g., diameter) in a range of from 1 Å to 20 Å (e.g., from 1 Å to 10 Å, from 3 Å to 8 Å, from 4 Å to 5 Å) [e.g., from 1.5 Å (e.g., 1.56 Å) to 16.5 Å (e.g., 16.45 Å)]. In some embodiments, each of the inorganic particles comprises one or more pores that connect to form at least one channel through the inorganic particle.

In some embodiments, the at least one channel for each of the inorganic particles are connected to form a channel system. In some embodiments, the channel system is a 1-dimensional, 2-dimensional, or 3-dimensional channel system. In some embodiments, the channel system extends throughout the separator [e.g., from a first surface of the separator to a second surface of the separator that opposes the first surface (e.g., from an anode side to a cathode side)].

In some embodiments, the inorganic particles comprise one or more cage structures. In some embodiments, at least one of the one or more cage structures is disposed at an intersection of pores of the inorganic particles. In some embodiments, each of the one or more cage structures has a size (e.g., diameter) in a range of from 1 Å to 20 Å (e.g., from 1 Å to 10 Å, from 5 Å to 15 Å, from 10 Å to 12 Å, from 3 Å to 8 Å, from 5 Å to 7 Å or from 6 Å to 7 Å). In some embodiments, at least one of the one or more cage structures is disposed in a 1-dimensional pore.

In some embodiments, one or more species are disposed in (e.g., adsorbed in) the one or more cage structures. In some embodiments, one or more species are disposed in (e.g., adsorbed in) one or more pores of the inorganic particles [e.g., on a surface of the one or more pores (e.g., an internal surface, near an opening, or both)]. In some embodiments, the one or more species comprise a member selected from the group consisting of olefinic hydrocarbons, paraffinic hydrocarbons, naphthenic hydrocarbons, and aromatic hydrocarbons. In some embodiments, the one or more species comprise water. In some embodiments, the one or more species comprise one or more gas species. In some embodiments, the one or more gas species are selected from the group consisting of hydrogen, oxygen, carbon oxides, nitrogen, argon, hydrogen disulfide, ammonia, nitric oxide, nitrogen oxides and sulfur oxides. In some embodiments, the one or more species comprise one or more cationic species. In some embodiments, the one or more cationic species are each a cationic form of an element selected from the group consisting of lithium, sodium, potassium, rubidium, cesium, beryllium, magnesium, calcium, strontium, barium, boron, aluminum, gallium, indium, thallium, carbon, germanium, tin, lead, nitrogen, phosphorous, arsenic, antimony, bismuth, scandium, titanium, vanadium, chromium, manganese, iron, cobalt, nickel, copper, zinc, yttrium, zirconium, niobium, molybdenum, ruthenium, rhodium, palladium, silver, cadmium, hafnium, tantalum, tungsten, rhenium, osmium, iridium, platinum, gold, mercury, lanthanum, cerium, praseodymium, neodymium, samarium, europium, gadolinium, terbium, dysprosium, holmium, erbium, thulium, ytterbium, lutetium, actinium, thorium, protactinium, uranium, neptunium, and plutonium. In some embodiments, the one or more species comprise one or more anionic species. In some embodiments, the one or more anionic species are selected from the group consisting of hydroxides, alkoxides, peroxides, superoxides, nitrates, nitrites, sulfates, sulfites, phosphates, phosphides, fluorides, chlorides, bromides, iodides, chlorates, bromates, iodates, polyoxymetalates, and combinations thereof.

In some embodiments, the inorganic particles have a surface area of at least 10 m²/g (e.g., at least 100 m²/g, at least 250 m²/g, at least 300 m²/g, at least 500 m²/g, or at least 700 m²/g).

In some embodiments, the inorganic particles comprises one or more particles having a composition of M_{y}AlₓSi₁₋ₓO₂·zH₂O, where M is a metal. In some embodiments, x is in a range of 0 to 0.5 (e.g., 0 to 0.1 or from 0.01 to 0.5) and y is in a range of 0 to 0.5 (e.g., 0 to 0.1). In some embodiments, x is in a range of from 0.5 to 1 and y is in a range of 0 to 1. In some embodiments, z is in a range of 0 to 10,000.

In some embodiments, polar sites are disposed on a surface of the inorganic particles [e.g., an internal surface (e.g., of a pore)]. In some embodiments, the inorganic particles are crystalline or amorphous. In some embodiments, the inorganic particles have an average particle size (d₅₀ diameter) in a range of from 100 nm to 30 μm.

In some embodiments, the inorganic particles comprise one or more particles having a spherical shape, one or more particles having a rod shape, one or more particles having a needle shape, one or more particles having a flake shape, one or more particles having a platelet shape, one or more particles having a cube shape, one or more particles having a disc shape, one or more particles having a tube shape, or a combination thereof.

In some embodiments, the inorganic particles have been prepared by a crystallization reaction of chemical precursors at 30-250° C. for no more than 30 days. In some embodiments, the reaction proceeded under stirring. In some embodiments, the crystallization reaction is performed without stirring. In some embodiments, the chemical precursors comprise a silica source and an alumina source. In some embodiments, the chemical precursors comprise a mineralizing agent, acidic or basic media, a templating agent, a structure directing agent (SDA), or a combination thereof.

The additive may be included in an electrode that further comprises an electroactive material. In some embodiments, the electrode further comprises a current collector, wherein the electroactive material and the additive are coated on the current collector.

In some embodiments, the electrode further comprises one or more binders. In some embodiments, the one or more binders are no more than 50 wt. % (e.g., no more than 40 wt. %, no more than 30 wt. %, no more than 20 wt. %, no more than 10 wt. %, no more than 5 wt. %, or no more than 1 wt. %) of the separator. In some embodiments, the one or more binders are selected from the group consisting of polyvinylidene fluoride (PVDF), polytetrafluoroethylene (PTFE), polyvinyl alcohol, polyvinylpyrrolidone (PVP), polyacrylic acid (PAA), polyurethane (PU), polyvinyl acetate, polyvinyl chloride (PVC), carboxymethyl cellulose (CMC), hydroxypropyl cellulose (HPC), hydroxyethyl cellulose (HEC), and styrene butadiene rubber (SBR).

In some embodiments, the electrode further comprises a conductive additive. In some embodiments, the conductive additive is no more than 80 wt. % (e.g., no more than 70 wt. %, no more than 60 wt. %, no more than 50 wt. %, no more than 40 wt. %, no more than 30 wt. %, no more than 20 wt. %, or no more than 10 wt. %) of the electrode. In some embodiments, the conductive additive is selected from the group consisting of carbon black, acetylene black, carbon fibers, carbon nanotubes, graphene, graphite, fullerenes, carbon aerogels, metal flakes, metal fibers, metal particles, and conductive polymers. In some embodiments, the conductive additive is a conductive polymer selected from the group consisting of polyaniline, polyacetylene, polyphenylene vinylene, polypyrrole, polythiophene, polyphenylene sulfide, polyfluorenes, polypyrenes, polyazulenes, polynapthalenes, poly(p-phenylene vinylene), poly(p-phenylene sulfide), and PEDOT.

In some embodiments, the inorganic particles are from 1 vol. % to 50 vol. % (e.g., from 5 vol. % to 30 vol. % or from 10 vol. % to 20 vol. %) of an active layer (e.g., coating or film) of the electrode.

In some embodiments, the inorganic particles are disposed on one or more surfaces of the electroactive material [e.g., surface(s) of micro- and/or nano-structures, such as particle(s) (e.g., rod(s) and/or sphere(s)), film(s), tube(s), and/or fiber(s)]. In some embodiments, the inorganic particles and the electroactive material together form one or more core-shell structures each having a core comprising at least a portion of the electroactive material and a shell comprising ones of the inorganic particles. In some embodiments, the inorganic particles are disposed in a layer (e.g., a uniform or non-uniform layer) that is disposed on (e.g., entirely around) a surface of one or more particles comprising the electroactive material. In some embodiments, the layer has a thickness of no more than 2 μm. In some embodiments, the inorganic particles are adhered to the one or more surfaces by electrostatic potential. In some embodiments, the inorganic particles and/or the electroactive material have been surface-modified (e.g., to alter electrostatic potential and/or hydrophobicity).

In some embodiments, the electroactive material [e.g., surface(s) of micro- and/or nano-structures, such as particle(s) (e.g., rod(s) and/or sphere(s)), film(s), tube(s), and/or fiber(s)] and the inorganic particles are dispersed throughout the electrode.

The electrode may be included in an energy storage device. In some embodiments, the energy storage device further includes a separator disposed between the two electrodes such that the separator prevents direct physical contact of the two electrodes. In some embodiments, the energy storage device further comprises an electrolyte disposed between the two electrodes. In some embodiments, the energy storage device is a primary battery, a secondary battery, a secondary battery, a fuel cell, or a capacitor. In some embodiments, the energy storage device is an aqueous battery (e.g., an aqueous secondary battery or an aqueous primary battery).

In some aspects, the present disclosure is directed to a separator or electrode additive for an energy storage device, the separator or electrode additive comprising a functional material comprising: (i) one or more organic ligands, one or more non-metallic oxides, or a combination thereof; or (ii) partially reduced graphene oxide, partially reduced graphite oxide, or a combination thereof.

In some embodiments, the functional material comprises the one or more organic ligands. In some embodiments, the one or more organic ligands are doped. In some embodiments, the one or more organic ligands comprise one or more elements selected from the group consisting of sodium, potassium, calcium, barium, cesium, scandium, cadmium, magnesium, iron, manganese, lithium, zinc, zirconium, niobium, yttrium, molybdenum, hafnium, osmium, nickel, cobalt, germanium, beryllium, mercury, tungsten, platinum, rubidium, ruthenium, rhodium, palladium, antimony, tellurium, bismuth, arsenic, lead, lanthanum, europium, gadolinium, cerium, tin, chromium, vanadium, titanium, aluminum, tantalum, gallium, indium, silver, gold, copper, carbon, hydrogen, boron, oxygen, nitrogen, fluorine, chlorine, bromine, and iodine. In some embodiments, the one or more organic ligands comprise one or more water molecules (e.g., coordinated and/or bonded to a backbone ligand).

In some embodiments, the functional material comprises the one or more non-metallic oxides. In some embodiments, the one or more non-metallic oxides are doped. In some embodiments, the one or more non-metallic oxides comprise one or more dopants selected from the group consisting of sodium, potassium, calcium, barium, cesium, scandium, cadmium, magnesium, iron, manganese, lithium, zinc, zirconium, niobium, yttrium, molybdenum, hafnium, osmium, nickel, cobalt, germanium, beryllium, mercury, tungsten, platinum, rubidium, ruthenium, rhodium, palladium, antimony, tellurium, bismuth, arsenic, lead, lanthanum, europium, gadolinium, cerium, tin, chromium, vanadium, titanium, aluminum, tantalum, gallium, indium, silver, gold, copper, carbon, hydrogen, boron, oxygen, nitrogen, fluorine, chlorine, bromine, and iodine.

In some embodiments, the functional material comprises the partially reduced graphene oxide. In some embodiments, the partially reduced graphene oxide is doped. In some embodiments, the partially reduced graphene oxide comprise one or more dopants selected from the group consisting of sodium, potassium, calcium, barium, cesium, scandium, cadmium, magnesium, iron, manganese, lithium, zinc, zirconium, niobium, yttrium, molybdenum, hafnium, osmium, nickel, cobalt, germanium, beryllium, mercury, tungsten, platinum, rubidium, ruthenium, rhodium, palladium, antimony, tellurium, bismuth, arsenic, lead, lanthanum, europium, gadolinium, cerium, tin, chromium, vanadium, titanium, aluminum, tantalum, gallium, indium, silver, gold, copper, carbon, hydrogen, boron, oxygen, nitrogen, fluorine, chlorine, bromine, and iodine. In some embodiments, the partially reduced graphene oxide is coordinated and/or bonded (e.g., hydrogen bonded) to one or more water molecules.

In some embodiments, the functional material comprises the partially reduced graphite oxide. In some embodiments, the partially reduced graphite oxide is doped. In some embodiments, the partially reduced graphite oxide comprise one or more dopants selected from the group consisting of sodium, potassium, calcium, barium, cesium, scandium, cadmium, magnesium, iron, manganese, lithium, zinc, zirconium, niobium, yttrium, molybdenum, hafnium, osmium, nickel, cobalt, germanium, beryllium, mercury, tungsten, platinum, rubidium, ruthenium, rhodium, palladium, antimony, tellurium, bismuth, arsenic, lead, lanthanum, europium, gadolinium, cerium, tin, chromium, vanadium, titanium, aluminum, tantalum, gallium, indium, silver, gold, copper, carbon, hydrogen, boron, oxygen, nitrogen, fluorine, chlorine, bromine, and iodine. In some embodiments, the partially reduced graphite oxide is coordinated and/or bonded (e.g., hydrogen bonded) to one or more water molecules.

In some embodiments, the functional material is crystalline or amorphous.

In some embodiments, the functional material is comprised in particles. In some embodiments, the particles comprise one or more particles having a spherical shape, one or more particles having a rod shape, one or more particles having a needle shape, one or more particles having a flake shape, one or more particles having a platelet shape, one or more particles having a cubic shape, one or more particles having a disc shape, one or more particles having a tube shape, or a combination thereof.

In some embodiments, the functional material is porous (e.g., is comprised in porous particles). In some embodiments, the functional material has microporosity, mesoporosity, macroporosity, or a combination thereof. In some embodiments, the functional material comprises one or more pores having a size (e.g., diameter) of less than 2 nm. In some embodiments, the functional material comprises one or more pores having a size (e.g., diameter) of at least 2 nm and no more than 50 nm. In some embodiments, the functional material comprises one or more pores having a size (e.g., diameter) of more than 50 nm. In some embodiments, the functional material comprises one or more pores having a size (e.g., diameter) in a range of from 1 Å to 20 Å (e.g., from 1 Å to 10 Å, from 3 Å to 8 Å, from 4 Å to 5 Å) [e.g., from 1.5 Å (e.g., 1.56 Å) to 16.5 Å (e.g., 16.45 Å)]. In some embodiments, the functional material comprises one or more pores that connect to form at least one channel through the functional material. In some embodiments, the at least one channel is connected to form a channel system. In some embodiments, the channel system is a 1-dimensional, 2-dimensional, or 3-dimensional channel system. In some embodiments, the channel system extends throughout the functional material [e.g., from a first surface of the separator to a second surface of the separator that opposes the first surface (e.g., from an anode side to a cathode side)].

In some embodiments, one or more species are disposed in (e.g., adsorbed in) one or more pores of the functional material [e.g., on a surface of the one or more pores (e.g., an internal surface, near an opening, or both)]. In some embodiments, the one or more species comprise a member selected from the group consisting of olefinic hydrocarbons, paraffinic hydrocarbons, naphthenic hydrocarbons, and aromatic hydrocarbons. In some embodiments, the one or more species comprise water. In some embodiments, the one or more species comprise one or more gas species. In some embodiments, the one or more gas species are selected from the group consisting of hydrogen, oxygen, carbon oxides, nitrogen, argon, hydrogen disulfide, ammonia, nitric oxide, nitrogen oxides and sulfur oxides. In some embodiments, the one or more species comprise one or more cationic species. In some embodiments, the one or more cationic species are each a cationic form of an element selected from the group consisting of lithium, sodium, potassium, rubidium, cesium, beryllium, magnesium, calcium, strontium, barium, boron, aluminum, gallium, indium, thallium, carbon, germanium, tin, lead, nitrogen, phosphorous, arsenic, antimony, bismuth, scandium, titanium, vanadium, chromium, manganese, iron, cobalt, nickel, copper, zinc, yttrium, zirconium, niobium, molybdenum, ruthenium, rhodium, palladium, silver, cadmium, hafnium, tantalum, tungsten, rhenium, osmium, iridium, platinum, gold, mercury, lanthanum, cerium, praseodymium, neodymium, samarium, europium, gadolinium, terbium, dysprosium, holmium, erbium, thulium, ytterbium, lutetium, actinium, thorium, protactinium, uranium, neptunium, and plutonium. In some embodiments, the one or more species comprise one or more anionic species. In some embodiments, the one or more anionic species are selected from the group consisting of hydroxides, alkoxides, peroxides, superoxides, nitrates, nitrites, sulfates, sulfites, phosphates, phosphides, fluorides, chlorides, bromides, iodides, chlorates, bromates, iodates, polyoxymetalates, and combinations thereof.

In some embodiments, the functional material has a surface area of at least 10 m²/g (e.g., at least 100 m²/g, at least 250 m²/g, at least 300 m²/g, at least 500 m²/g, or at least 700 m²/g). In some embodiments, the functional material is comprised in particles and the particles have an average particle size (D₅₀) from 100 nm to 30 μm.

The additive may be included in a separator that further includes one or more binders. In some embodiments, the one or more binders are no more than 50 wt. % (e.g., no more than 40 wt. %, no more than 30 wt. %, no more than 20 wt. %, no more than 10 wt. %, no more than 5 wt. %, or no more than 1 wt. %) of the separator. In some embodiments, the one or more binders are selected from the group consisting of polyvinylidene fluoride (PVDF), polytetrafluoroethylene (PTFE), polyvinyl alcohol, polyvinylpyrrolidone (PVP), polyacrylic acid (PAA), polyurethane (PU), polyvinyl acetate, polyvinyl chloride (PVC), carboxymethyl cellulose (CMC), hydroxypropyl cellulose (HPC), hydroxyethyl cellulose (HEC), and styrene butadiene rubber (SBR). In some embodiments, at least one of the one or more binders comprises one or more binder additives. In some embodiments, the one or more binder additives comprise one or more members selected from the group consisting of pH adjusters, pH buffers, rheological modifiers, de-foamers, anti-foamers, adhesion promoters, and leveling agents. In some embodiments, the separator further includes a conductive polymer. In some embodiments, the conductive polymer is no more than 80 wt. % (e.g., no more than 70 wt. %, no more than 60 wt. %, no more than 50 wt. %, no more than 40 wt. %, no more than 30 wt. %, no more than 20 wt. %, or no more than 10 wt. %) of the separator. In some embodiments, the conductive polymer is selected from the group consisting of polyaniline, polyacetylene, polyphenylene vinylene, polypyrrole, polythiophene, polyphenylene sulfide, polyfluorenes, polypyrenes, polyazulenes, polynapthalenes, poly(p-phenylene vinylene), poly(p-phenylene sulfide), and PEDOT.

In some embodiments, the separator has been in situ or ex situ coated on an electrode (e.g., an anode, a cathode, or both) (e.g., by wet chemical reaction, physical vapor deposition, chemical vapor deposition, atomic layer deposition, sintering, pressing, hot pressing, extrusion, die casting, slot-die coating, doctor-blade coating, dip coating, or a combination thereof) (e.g., by a liquid coating method). In some embodiments, the separator has further been calendared (e.g., thereby increasing adhesive strength, layer uniformity, or both), annealed, or both.

In some embodiments, the separator has a thickness in a range of from 5 μm to 500 μm. In some embodiments, the separator is a free-standing film.

The additive may be included in an electrode that further includes an electroactive material. In some embodiments, the electrode further includes a current collector, wherein the electroactive material and the additive are coated on the current collector. In some embodiments, the electrode further includes one or more binders. In some embodiments, the one or more binders are no more than 50 wt. % (e.g., no more than 40 wt. %, no more than 30 wt. %, no more than 20 wt. %, no more than 10 wt. %, no more than 5 wt. %, or no more than 1 wt. %) of the separator. In some embodiments, the one or more binders are selected from the group consisting of polyvinylidene fluoride (PVDF), polytetrafluoroethylene (PTFE), polyvinyl alcohol, polyvinylpyrrolidone (PVP), polyacrylic acid (PAA), polyurethane (PU), polyvinyl acetate, polyvinyl chloride (PVC), carboxymethyl cellulose (CMC), hydroxypropyl cellulose (HPC), hydroxyethyl cellulose (HEC), and styrene butadiene rubber (SBR). In some embodiments, the electrode further includes a conductive additive. In some embodiments, the conductive additive is no more than 80 wt. % (e.g., no more than 70 wt. %, no more than 60 wt. %, no more than 50 wt. %, no more than 40 wt. %, no more than 30 wt. %, no more than 20 wt. %, or no more than 10 wt. %) of the electrode. In some embodiments, the conductive additive is selected from the group consisting of carbon black, acetylene black, carbon fibers, carbon nanotubes, graphene, graphite, fullerenes, carbon aerogels, metal flakes, metal fibers, metal particles, and conductive polymers. In some embodiments, the conductive additive is a conductive polymer selected from the group consisting of polyaniline, polyacetylene, polyphenylene vinylene, polypyrrole, polythiophene, polyphenylene sulfide, polyfluorenes, polypyrenes, polyazulenes, polynapthalenes, poly(p-phenylene vinylene), poly(p-phenylene sulfide), and PEDOT.

In some embodiments, the functional material is from 1 vol. % to 50 vol. % (e.g., from 5 vol. % to 30 vol. % or from 10 vol. % to 20 vol. %) of an active layer (e.g., coating or film) of the electrode.

In some embodiments, the functional material is disposed on one or more surfaces of the electroactive material [e.g., surface(s) of micro- and/or nano-structures, such as particle(s) (e.g., rod(s) and/or sphere(s)), film(s), tube(s), and/or fiber(s)]. In some embodiments, the functional material and the electroactive material together form one or more core-shell structures each having a core comprising at least a portion of the electroactive material and a shell comprising the functional material. In some embodiments, the functional material disposed in a layer (e.g., a uniform or non-uniform layer) that is disposed on (e.g., entirely around) a surface of one or more particles comprising the electroactive material. In some embodiments, the layer has a thickness of no more than 2 μm. In some embodiments, the functional material is adhered to one or more surfaces by electrostatic potential. In some embodiments, the functional material and/or the electroactive material has been surface-modified (e.g., to alter electrostatic potential and/or hydrophobicity).

Any two or more of the features described in this specification, including in this summary section, may be combined to form implementations, for example of an energy storage device, not specifically explicitly described in this specification.

### BRIEF DESCRIPTION OF THE DRAWINGS

Drawings are presented herein for illustration purposes, not for limitation. The foregoing and other objects, aspects, features, and advantages of the disclosure will become more apparent and may be better understood by referring to the following description taken in conjunction with the accompanying drawings, in which:

FIG. 1A illustrates a particle with a one-dimensional channel system, according to illustrative embodiments of the present disclosure;

FIG. 1B illustrates a particle with a two-dimensional channel system, according to illustrative embodiments of the present disclosure;

FIG. 1C illustrates a particle with a one-dimensional channel system and cage structures, according to illustrative embodiments of the present disclosure;

FIG. 2 is a cross-section of a battery that includes two electrode layers and a separator layer each including particles, according to illustrative embodiments of the present disclosure; and

FIG. 3 is a perspective representation of a coin cell assembly, according to illustrative embodiments of the present disclosure.

Schematics are not necessarily drawn to scale.

### DETAILED DESCRIPTION OF CERTAIN EMBODIMENTS

In this application, unless otherwise clear from context or otherwise explicitly stated, (i) the term “a” may be understood to mean “at least one”; (ii) the term “or” may be understood to mean “and/or”; (iii) the terms “comprising” and “including” may be understood to encompass itemized components or steps whether presented by themselves or together with one or more additional components or steps; (iv) the terms “about” and “approximately” may be understood to permit standard variation as would be understood by those of ordinary skill in the relevant art; and (v) where ranges are provided, endpoints are included.

It is contemplated that systems, devices, methods, and processes of the disclosure encompass variations and adaptations developed using information from the embodiments described herein. Adaptation and/or modification of the systems, devices, methods, and processes described herein may be performed by those of ordinary skill in the relevant art. Throughout the description, where articles, devices, and systems are described as having, including, or comprising specific components, or where processes and methods are described as having, including, or comprising specific steps, it is contemplated that, additionally, there are articles, devices, and systems according to certain embodiments of the present disclosure that consist essentially of, or consist of, the recited components, and that there are processes and methods according to certain embodiments of the present disclosure that consist essentially of, or consist of, the recited processing steps. It should be understood that the order of steps or order for performing certain action is immaterial so long as operability is not lost. Moreover, two or more steps or actions may be conducted simultaneously. As is understood by those skilled in the art, the terms “over”, “under”, “above”, “below”, “beneath”, and “on” are relative terms and can be interchanged in reference to different orientations of the layers, elements, and substrates included in the present disclosure. For example, a first layer on a second layer, in some embodiments means a first layer directly on and in contact with a second layer. In other embodiments, a first layer on a second layer can include another layer there between. Headers are provided for the convenience of the reader and are not intended to be limiting with respect to the claimed subject matter.

Described herein are, inter alia, separators and additives (e.g., electrode additives) for use in energy storage devices. In certain embodiments, a separator includes inorganic particles. In certain embodiments, an additive includes inorganic particles. The additive may be used in an electrode, such as a cathode or anode in a battery. The inorganic particles (whether included in a separator or used in (e.g., as) an additive, for example for an electrode) may be functional inorganic particles that promote battery performance and/or safety. For example, the functional inorganic particles may act to reduce or eliminate side reactions or mitigate the effects of side reactions during electrochemical cycling of an energy storage device in which they are included (e.g., discharge and/or charge of a battery). As another example, the functional inorganic particles may additionally or alternatively promote ionic conductivity. In certain embodiments, a separator and/or an additive includes one or more functional materials that each include one or more organic ligands, one or more non-metallic oxides, or a combination thereof. In certain embodiments, a separator includes partially reduced graphene oxide, partially reduced graphite oxide, or a combination thereof.

An energy storage device may include a separator as disclosed herein, an additive disclosed herein (e.g., included in an electrode), or both. The energy storage device may be, for example, a battery, a fuel cell, or a capacitor. The battery may be a primary battery or a secondary battery. Independently of whether it is primary or secondary, the battery may be an aqueous battery or a non-aqueous battery (e.g., that includes a solid-state electrolyte). The battery may be an ion battery, such as an aluminum-ion, a sodium-ion battery, a potassium-ion battery, a proton battery, a calcium-ion battery, a manganese-ion battery, a lithium-ion battery, an air battery, or a combination of one or more, for example. The energy storage device need not have a specific cell construction, cathode composition, anode composition, electrolyte composition, or composition of any other electrode.

### Separators

In some embodiments, a separator for an energy storage device (e.g., electrochemical cell) includes inorganic particles. The separator may also include one or more binders to bind the inorganic particles together. The inorganic particles may be functional inorganic particles. The separator is a solid or semi-solid (e.g., gel or gelatinous) layer. For example, a semi-solid layer may be a surface layer, for example formed in situ or ex situ (e.g., by coating while in contact with a mixture (e.g., solution)). Such a surface layer may act as a separator when disposed between two electrodes in an electrochemical cell. A solid separator may be, for example, a free-standing film, for example formed ex situ and then disposed between two electrodes. The following description provides, inter alia, inorganic particles of different types (e.g., different compositions, sizes, morphologies, porosity, or combination thereof). A separator may include inorganic particles of only one type or of different types mixed together.

In some embodiments, inorganic particles are at least 50 wt. % (e.g., at least 60 wt. %, at least 70 wt. %, at least 80 wt. %, at least 90 wt. %, or at least 95 wt. %) of a separator. Inorganic particles may include oxygen, hydrogen, aluminum, silicon, phosphorous, a metal atom, or a combination thereof. Usable metal atoms include aluminum, silicon, lithium, sodium, potassium, rubidium, cesium, beryllium, magnesium, calcium, strontium, barium, boron, gallium, indium, thallium, carbon, germanium, tin, lead, nitrogen, phosphorous, arsenic, antimony, bismuth, scandium, titanium, vanadium, chromium, manganese, iron, cobalt, nickel, copper, zinc, yttrium, zirconium, niobium, molybdenum, ruthenium, rhodium, palladium, silver, cadmium, hafnium, tantalum, tungsten, rhenium, osmium, iridium, platinum, gold, mercury, lanthanum, cerium, praseodymium, neodymium, samarium, europium, gadolinium, terbium, dysprosium, holmium, erbium, thulium, ytterbium, lutetium, actinium, thorium, protactinium, uranium, neptunium, and plutonium. One or more elements comprised in inorganic particles may be at least 10 wt. % (e.g., at least 20 wt. %, at least 30 wt. %, or at least 50 wt. %) of the inorganic particles. Alternatively or additionally, one or more metal atoms comprised in inorganic particles may be no more than 80 wt. % (e.g., no more than 50 wt. %, no more than 30 wt. %, no more than 20 wt. %) of the inorganic particles. Inorganic particles may have a composition of M_{y}AlₓSi₁₋ₓO₂·zH₂O, where M is a metal. X may be in a range of 0 to 0.5 (e.g., 0 to 0.1 or from 0.01 to 0.5) while y is in a range of 0 to 0.5 (e.g., 0 to 0.1). X may be in a range of from 0.5 to 1 while y is in a range of 0 to 1. Z may be in a range of 0 to 10,000. Inorganic particles may be crystalline, amorphous, or a combination thereof. Inorganic particles may have an average particle size (D₅₀) in a range of 100 nm-30 μm. Inorganic particles may have a shape of spheres, rods, needles, flakes, platelets, cubes, discs, or tubes.

Inorganic particles may be porous. The porosity can be microporosity, mesoporosity, macroporosity, or a combination thereof. Inorganic particles may include one or more pores that are less than 2 nm in size (e.g., diameter). Inorganic particles may include one or more pores that of at least 2 nm and no more than 50 nm in size (e.g., diameter). Inorganic particles may include one or more pores that are more than 50 nm in size (e.g., diameter). In some embodiments, inorganic particles include one or more pores having a size (e.g., diameter) in a range of from 1 Å to 20 Å (e.g., from 1 Å to 10 Å, from 3 Å to 8 Å, from 4 Å to 5 Å) [e.g., from 1.5 Å (e.g., 1.56 Å) to 16.5 Å (e.g., 16.45 Å)]. Inorganic particles may have a surface area of at least 10 m²/g (e.g., at least 100 m²/g, at least 250 m²/g, at least 300 m²/g, at least 500 m²/g, or at least 700 m²/g), for example as a result of their porosity.

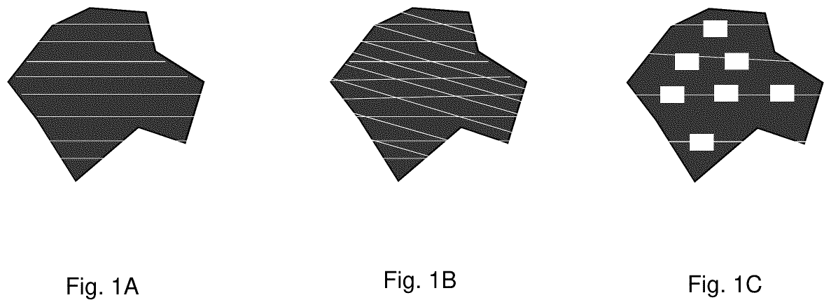

One or more pores of an inorganic particle may connect to form one or more channels. The one or more channels of one or more inorganic particles may intersect to form one or more channel systems, for example extending through a particle, or in some embodiments through a separator (e.g., through multiple particles). A channel system may be a 1-, 2- or 3-dimensional channel system. FIG. 1A illustrates an example of one dimensional pores that form a one dimensional channel system through a particle. FIG. 1B illustrates an example of two dimensional pores that form a two dimensional channel system. While the pores are shown as straight in FIGS. 1A-1B, this need not necessarily be; pores can follow complex (non-linear) paths into and/or through a particle. (FIGS. 1A-1B do not illustrate a three-dimensional channel system, which would include pores in a third dimension (into and out of the page with respect to FIG. 1B, for example.) In some embodiments, one or more cage structures exist at the intersection of two or more pores. A cage structure can be located at an intersection of pores. A cage structure can be located within one or more 1-dimensional pores. FIG. 1C illustrates an example of cage structures located within one or more 1-dimensional pores.

In certain embodiments, one or more pores and/or one or more cage structures have one or more species disposed therein. For example, one or more species may be absorbed into one or more pores and/or one or more cage structures and not covalently bound to the inorganic particles. One or more species disposed in a pore and/or cage structure may be, for example, adsorbed onto a surface of the pore and/or cage structure (e.g., an interior surface or an opening), absorbed into the pore and/or cage structure, or both. The size, shape, dimensionality, and hydrophobicity/hydrophilicity environment of the pore(s) and/or cage structures may determine which one or more species may be suitable for, contained in, and/or absorbed in such pores. For example, larger pores may be used to accommodate a larger species while a smaller pore is used for a smaller species. Similarly, a separator may include a first type of inorganic particles that include hydrophobic pores may have a hydrophobic species adsorbed thereon and a second type of inorganic particles that include hydrophilic (or less hydrophobic) pores may have a hydrophilic (or less hydrophobic) species adsorbed thereon. The hydrophobicity/hydrophilicity environment of inorganic particles can be tuned, for example, via modification of chemical composition of the particles and/or via surface treatment. Incorporation of different species (e.g., different atomic and/or ionic species) can change overall polarity of a surface and thus the hydrophobicity/hydrophilicity.

One or more species that are disposed in one or more pores and/or one or more cage structures may be or include water, olefinic hydrocarbons, paraffinic hydrocarbons, naphthenic hydrocarbons, aromatic hydrocarbons, or a combination thereof. One or more gas species may be included in (e.g., on a surface of) one or more pores and/or one or more cage structures. The one or more gas species may include hydrogen, oxygen, a carbon oxide (e.g., carbon dioxide), nitrogen, argon, hydrogen disulfide, ammonia, nitric oxide, a nitrogen oxide (e.g., nitrogen dioxide), a sulfur oxide (e.g., sulfur dioxide), or a combination thereof. One or more cationic species may be included in (e.g., on a surface of) one or more pores and/or one or more cage structures. The one or more cationic species may include a cationic form of lithium, sodium, potassium, rubidium, cesium, beryllium, magnesium, calcium, strontium, barium, boron, aluminum, gallium, indium, thallium, carbon, germanium, tin, lead, nitrogen, phosphorous, arsenic, antimony, bismuth, scandium, titanium, vanadium, chromium, manganese, iron, cobalt, nickel, copper, zinc, yttrium, zirconium, niobium, molybdenum, ruthenium, rhodium, palladium, silver, cadmium, hafnium, tantalum, tungsten, rhenium, osmium, iridium, platinum, gold, mercury, lanthanum, cerium, presidium, neodymium, samarium, europium, gadolinium, terbium, dysprosium, holmium, erbium, thulium, ytterbium, lutetium, actinium, thorium, protactinium, uranium, neptunium, plutonium, or a combination thereof. One or more anionic species can be located in (e.g., disposed on a surface of) one or more cage structures and/or one or more pores. The one or more anionic species may include polyatomic anions. The one or more anionic species may include a hydroxide, an alkoxide, a peroxide, a superoxide, a nitrate, a nitrite, a sulfate, a sulfite, a phosphate, a phosphide, a fluoride, a chloride, a bromide, an iodide, a chlorate, a bromate, an iodate, a polyoxymetalates, or a combination thereof. Suitable methods for inserting and substituting species into pore(s) and/or cage structure(s) of inorganic particles are known to those of ordinary skill in the art.

An example of an inorganic particle (e.g., a functional inorganic particle) is a structure having a general chemical composition M_{y}AlₓSi₁₋ₓO₂·zH₂O, where x is in the range of 0 to 0.1, y is in the range of 0 to 0.1, and z is in the range of 0 to 10,000. M may be any one or more of the following: Li (lithium), Na (sodium), K (potassium), Rb (rubidium), Cs (cesium), Be (beryllium), Mg (magnesium), Ca (calcium), Sr (strontium), Ba (barium), B (boron), Ga (gallium), In (indium), Tl (thallium), C (carbon), Ge (germanium), Sn (tin), Pb (lead), N (nitrogen), P (phosphorous), As (arsenic), Sb (antimony), Bi (bismuth), Sc (scandium), Ti (titanium), V (vanadium), Cr (chromium), Mn (manganese), Fe (iron), Co (cobalt), Ni (nickel), Cu (copper), Zn (zinc), Y (yttrium), Zr (zirconium), Nb (niobium), Mo (molybdenum), Ru (ruthenium), Rh (rhodium), Pd (palladium), Ag (silver), Cd (cadmium), Hf (hafnium), Ta (tantalum), W (tungsten), Re (rhenium), Os (osmium), Ir (iridium), Pt (platinum), Au (gold), Hg (mercury), La (lanthanum), Ce (cerium), Pr (praseodymium), Nd (neodymium), Sm (samarium), Eu (europium), Gd (gadolinium), Tb (terbium), Dy (dysprosium), Ho (holmium), Er (erbium), Th (thulium), Yb (ytterbium), Lu (lutetium), Ac (actinium), Th (thorium), Pa (protactinium), U (uranium), Np (neptunium), Pu (plutonium). This inorganic particle has three-dimensional interconnected pore structures defining a three-dimensional channel system. These pores have openings that range in size from 1-10 Å, preferably between 3 Å and 8 Å, and more preferably between 4 Å and 5 Å. These three-dimensional pores intersect to create cage structures with a diameter in the range of 1 Å and 10 Å, preferably between 3 Å and 8 Å, and more preferably between 6 Å and 7 Å. These inorganic particles typically have surface areas of at least 10 m²/g, preferably at least 100 m²/g, and more preferably at least 300 m²/g. A plurality of these inorganic particles can be included in a separator, for example bound together with one or more binders.

Another example of an inorganic particle (e.g., a functional inorganic particle) is a structure having a general chemical composition M_{y}AlₓSi₁₋ₓO₂·zH₂O, where x is in the range of 0 to 0.5, y is in the range of 0 to 0.5 and z is in the range of 0 to 10,000. M may be any one or more of the following: Li (lithium), Na (sodium), K (potassium), Rb (rubidium), Cs (cesium), Be (beryllium), Mg (magnesium), Ca (calcium), Sr (strontium), Ba (barium), B (boron), Ga (gallium), In (indium), Tl (thallium), C (carbon), Ge (germanium), Sn (tin), Pb (lead), N (nitrogen), P (phosphorous), As (arsenic), Sb (antimony), Bi (bismuth), Sc (scandium), Ti (titanium), V (vanadium), Cr (chromium), Mn (manganese), Fe (iron), Co (cobalt), Ni (nickel), Cu (copper), Zn (zinc), Y (yttrium), Zr (zirconium), Nb (niobium), Mo (molybdenum), Ru (ruthenium), Rh (rhodium), Pd (palladium), Ag (silver), Cd (cadmium), Hf (hafnium), Ta (tantalum), W (tungsten), Re (rhenium), Os (osmium), Ir (iridium), Pt (platinum), Au (gold), Hg (mercury), La (lanthanum), Ce (cerium), Pr (praseodymium), Nd (neodymium), Sm (samarium), Eu (europium), Gd (gadolinium), Tb (terbium), Dy (dysprosium), Ho (holmium), Er (erbium), Th (thulium), Yb (ytterbium), Lu (lutetium), Ac (actinium), Th (thorium), Pa (protactinium), U (uranium), Np (neptunium), Pu (plutonium). This inorganic particle has three-dimensional interconnected pores defining a three-dimensional channel system. These pores have openings that range in size from 1-10 Å, preferably between 3 Å and 8 Å, and more preferably between 7 Å and 8 Å. These three-dimensional pores intersect to create cage structures with a diameter in the range of 1 Å and 20 Å, preferably between 5 Å and 15 Å, and more preferably between 11 Å and 12 Å. These inorganic particles typically have surface areas of at least 10 m²/g, preferably at least 250 m²/g, and more preferably at least 700 m²/g. A plurality of these inorganic particles can be included in a separator, for example bound together with one or more binders.

Another example of an inorganic particle (e.g., a functional inorganic particle) is a structure having a general chemical composition of M_{y}AlₓSi₁₋ₓO₂·zH₂O, where x is in the range of 0.5-1, y is in the range of 0-1 and z is in the range of 0-10,000. M may be any one or more of the following: Li (lithium), Na (sodium), K (potassium), Rb (rubidium), Cs (cesium), Be (beryllium), Mg (magnesium), Ca (calcium), Sr (strontium), Ba (barium), B (boron), Ga (gallium), In (indium), Tl (thallium), C (carbon), Ge (germanium), Sn (tin), Pb (lead), N (nitrogen), P (phosphorous), As (arsenic), Sb (antimony), Bi (bismuth), Sc (scandium), Ti (titanium), V (vanadium), Cr (chromium), Mn (manganese), Fe (iron), Co (cobalt), Ni (nickel), Cu (copper), Zn (zinc), Y (yttrium), Zr (zirconium), Nb (niobium), Mo (molybdenum), Ru (ruthenium), Rh (rhodium), Pd (palladium), Ag (silver), Cd (cadmium), Hf (hafnium), Ta (tantalum), W (tungsten), Re (rhenium), Os (osmium), Ir (iridium), Pt (platinum), Au (gold), Hg (mercury), La (lanthanum), Ce (cerium), Pr (praseodymium), Nd (neodymium), Sm (samarium), Eu (europium), Gd (gadolinium), Tb (terbium), Dy (dysprosium), Ho (holmium), Er (erbium), Th (thulium), Yb (ytterbium), Lu (lutetium), Ac (actinium), Th (thorium), Pa (protactinium), U (uranium), Np (neptunium), Pu (plutonium). This inorganic particle has three-dimensional interconnected pore structures defining a three-dimensional channel system. These pores have openings that range in size from 1-10 Å, preferably between 3 Å and 8 Å, and more preferably between 4 Å and 5 Å. These three-dimensional pores intersect to create cage structures with a diameter in the range of 1 Å and 20 Å, preferably between 5 Å and 15 Å, and more preferably between 10 Å and 12 Å. These inorganic particles typically have surface areas of at least 10 m²/g, preferably at least 250 m²/g, and more preferably at least 500 m²/g. A plurality of these inorganic particles can be included in a separator, for example bound together with one or more binders.

Another example of an inorganic particle (e.g., a functional inorganic particle) is a structure having a general chemical composition of M_{y}AlₓSi₁₋ₓO₂·zH₂O, where x is in the range of 0.01 to 0.5 and y is in the range of 0-0.5, and z is in the range of 0-10,000. M may be any one or more of the following: Li (lithium), Na (sodium), K (potassium), Rb (rubidium), Cs (cesium), Be (beryllium), Mg (magnesium), Ca (calcium), Sr (strontium), Ba (barium), B (boron), Ga (gallium), In (indium), Tl (thallium), C (carbon), Ge (germanium), Sn (tin), Pb (lead), N (nitrogen), P (phosphorous), As (arsenic), Sb (antimony), Bi (bismuth), Sc (scandium), Ti (titanium), V (vanadium), Cr (chromium), Mn (manganese), Fe (iron), Co (cobalt), Ni (nickel), Cu (copper), Zn (zinc), Y (yttrium), Zr (zirconium), Nb (niobium), Mo (molybdenum), Ru (ruthenium), Rh (rhodium), Pd (palladium), Ag (silver), Cd (cadmium), Hf (hafnium), Ta (tantalum), W (tungsten), Re (rhenium), Os (osmium), Ir (iridium), Pt (platinum), Au (gold), Hg (mercury), La (lanthanum), Ce (cerium), Pr (praseodymium), Nd (neodymium), Sm (samarium), Eu (europium), Gd (gadolinium), Tb (terbium), Dy (dysprosium), Ho (holmium), Er (erbium), Th (thulium), Yb (ytterbium), Lu (lutetium), Ac (actinium), Th (thorium), Pa (protactinium), U (uranium), Np (neptunium), Pu (plutonium). This inorganic particle has a three-dimensional interconnected pore structures defining a three-dimensional channel system. These pores have openings that range in size from 1-10 Å, preferably between 2 Å and 6 Å, and more preferably between 3 Å and 4 Å. These three-dimensional pores intersect to create cage structures with a diameter in the range of 1 Å and 20 Å, preferably between 5 Å and 15 Å, and more preferably between 7 Å and 8 Å. These inorganic particles typically have surface areas of at least 10 m²/g, preferably at least 250 m²/g, and more preferably at least 500 m²/g. A plurality of these inorganic particles can be included in a separator, for example bound together with one or more binders.

Another example of an inorganic particle (e.g., a functional inorganic particle) is a structure having a general chemical composition M_{y}AlₓSi₁₋ₓO₂·zH₂O, where x is in the range of 0.01 to 0.5, y is in the range of 0 to 0.5, and z is in the range of 0-10,000. M may be any one or more of the following: Li (lithium), Na (sodium), K (potassium), Rb (rubidium), Cs (cesium), Be (beryllium), Mg (magnesium), Ca (calcium), Sr (strontium), Ba (barium), B (boron), Ga (gallium), In (indium), Tl (thallium), C (carbon), Ge (germanium), Sn (tin), Pb (lead), N (nitrogen), P (phosphorous), As (arsenic), Sb (antimony), Bi (bismuth), Sc (scandium), Ti (titanium), V (vanadium), Cr (chromium), Mn (manganese), Fe (iron), Co (cobalt), Ni (nickel), Cu (copper), Zn (zinc), Y (yttrium), Zr (zirconium), Nb (niobium), Mo (molybdenum), Ru (ruthenium), Rh (rhodium), Pd (palladium), Ag (silver), Cd (cadmium), Hf (hafnium), Ta (tantalum), W (tungsten), Re (rhenium), Os (osmium), Ir (iridium), Pt (platinum), Au (gold), Hg (mercury), La (lanthanum), Ce (cerium), Pr (praseodymium), Nd (neodymium), Sm (samarium), Eu (europium), Gd (gadolinium), Tb (terbium), Dy (dysprosium), Ho (holmium), Er (erbium), Th (thulium), Yb (ytterbium), Lu (lutetium), Ac (actinium), Th (thorium), Pa (protactinium), U (uranium), Np (neptunium), Pu (plutonium). This inorganic particle comprises one-dimensional pores. These pores have openings that range in size from 1-10 Å, preferably between 1 Å and 8 Å, and more preferably between 1 Å and 7 Å. These inorganic particles typically have surface areas of at least 10 m²/g, preferably at least 150 m²/g, and more preferably at least 300 m²/g. A plurality of these inorganic particles can be included in a separator, for example bound together with one or more binders.

Another example of an inorganic particle (e.g., a functional inorganic particle) is a structure having a general chemical composition M_{y}AlₓSi₁₋ₓO₂·zH₂O, where x is in the range of 0.01 to 0.5, y is in the range of 0 to 0.5 and z is in the range of 0 to 10,000. M may be any one of the following Li (lithium), Na (sodium), K (potassium), Rb (rubidium), Cs (cesium), Be (beryllium), Mg (magnesium), Ca (calcium), Sr (strontium), Ba (barium), B (boron), Ga (gallium), In (indium), Tl (thallium), C (carbon), Ge (germanium), Sn (tin), Pb (lead), N (nitrogen), P (phosphorous), As (arsenic), Sb (antimony), Bi (bismuth), Sc (scandium), Ti (titanium), V (vanadium), Cr (chromium), Mn (manganese), Fe (iron), Co (cobalt), Ni (nickel), Cu (copper), Zn (zinc), Y (yttrium), Zr (zirconium), Nb (niobium), Mo (molybdenum), Ru (ruthenium), Rh (rhodium), Pd (palladium), Ag (silver), Cd (cadmium), Hf (hafnium), Ta (tantalum), W (tungsten), Re (rhenium), Os (osmium), Ir (iridium), Pt (platinum), Au (gold), Hg (mercury), La (lanthanum), Ce (cerium), Pr (praseodymium), Nd (neodymium), Sm (samarium), Eu (europium), Gd (gadolinium), Tb (terbium), Dy (dysprosium), Ho (holmium), Er (erbium), Th (thulium), Yb (ytterbium), Lu (lutetium), Ac (actinium), Th (thorium), Pa (protactinium), U (uranium), Np (neptunium), and Pu (plutonium). This inorganic particle has two-dimensional interconnected pore structures. These pores have openings that range in size from 1-10 Å, preferably between 1 Å and 8 Å, and more preferably between 1 Å and 5 Å. These two-dimensional pores intersect to create cage structures with a diameter in the range of 1 Å and 20 Å, preferably between 5 Å and 15 Å, and more preferably between 5 Å and 7 Å. These inorganic particles typically have surface areas of at least 10 m²/g, preferably at least 150 m²/g, and more preferably at least 300 m²/g. A plurality of these inorganic particles can be included in a separator, for example bound together with one or more binders.

Another example of an inorganic particle (e.g., a functional inorganic particle) is a structure having a general chemical composition MxOy where x is in the range of 0 to 2 and y is in the range of 0 to 5. M may be any one or more of the following: Mg (magnesium), Al (aluminum), Si (silicon), Ti (titanium), Mn (manganese), Ca (calcium), Zn (zinc), Sr (strontium), Y (yttrium), Zr (zirconium), Nb (niobium), Sn (tin), Sb (antimony), Ba (barium), La (lanthanum), Ce (cerium), Ta (tantalum), Bi (bismuth). In some embodiments, this inorganic particle may comprise a secondary particle. In some embodiments, the inorganic particle is nonporous. In some embodiments, the inorganic particle is amorphous. In other embodiments, the inorganic particle is partly or fully crystalline. These inorganic particles typically have surface areas of at least 0.1 m2/g and less than 1000 m2/g. Inorganic particles may be prepared via crystallization reaction of chemical precursors at 30-250° C. for 0-30 days, statically or under stirring conditions. The chemical precursors may include one or more of the following components: one a silica source, an alumina source, a mineralizing agent, acid or basic media, one or more templating agents or structure directing agents (SDAs). The inorganic particle may also be synthesized through mineral extraction, flame pyrolysis, or other methods known to those skilled in the art.

In some embodiments, in addition to inorganic particles, a separator includes one or more binders. The one or more binders may be no more than 50 wt. %, preferably no more than 20 wt. % of the separator. In some embodiments, the one or more binders are no more than 50 wt. % (e.g., no more than 40 wt. %, no more than 30 wt. %, no more than 20 wt. %, no more than 10 wt. %, no more than 5 wt. %, or no more than 1 wt. %) of the separator. The one or more binders may include polyvinylidene fluoride (PVDF), polytetrafluoroethylene (PTFE), polyvinyl alcohol, polyvinylpyrrolidone (PVP), polyacrylic acid (PAA), polyurethane (PU), polyvinyl acetate, polyvinyl chloride (PVC), carboxymethyl cellulose (CMC), hydroxypropyl cellulose (HPC), hydroxyethyl cellulose (HEC), styrene butadiene rubber (SBR) or a combination thereof. Optionally, a binder may include one or more additives. pH adjusters, pH buffers, rheological modifiers, de-foamers, anti-foamers, adhesion promoters, and leveling agents may be used as additives. In some embodiments, a separator may also include a conductive polymer. In some embodiments, the conductive polymer is no more than 80 wt. %, preferably no more than 50 wt. %, of the separator. A separator may include one or more of the following conductive polymers: polyaniline, polyacetylene, polyphenylene vinylene, polypyrrole, polythiophene, polyphenylene sulfide, polyfluorenes, polypyrenes, polyazulenes, polynapthalenes, poly(p-phenylene vinylene), poly(p-phenylene sulfide), PEDOT.

A separator may be coated ex situ directly on to one or more electrodes (e.g., an anode or a cathode or both an anode and a cathode). The coating technique can include, but is not limited to, one or more or a combination of wet chemical reaction, physical vapor deposition, chemical vapor deposition, atomic layer deposition, sintering, pressing, hot pressing, extrusion, die casting, slot-die coating, and doctor-blade coating. When a separator is coated using one or more liquid coating methods, the coating(s) may be prepared using any manner of mixing known to those familiar to the art. The coating(s) may be water-borne or solvent-borne, including inorganic particles and one or more binders. A wet coated layer may be disposed onto an electrode with a thickness in a range of from 5 μm to 500 μm. The coated layer may be dried in air at any temperature in the range of 25° C. to 200° C. The coated layer may be further subjected to calendaring to increase adhesive strength or layer uniformity or both. A temperature treatment such as annealing may also be employed. Further, a separator may or may not be used in conjunction with a liquid electrolyte (e.g., may be used with a solid electrolyte).

A separator comprising inorganic particles may also be prepared via dip coating of an electrode into a coating formulation containing inorganic particles. When the separator is coated using a dip coating method, the coating may be prepared using any manner of mixing known to those familiar to the art. The coating may be water-borne or solvent-borne, including inorganic particles and one or more binders.

In certain embodiments, a separator that comprises inorganic particles may be disposed on the surface of an electrode via in situ synthesis. In one example, this can be done via crystallization of a mixture of chemical precursors on an electrode (e.g., anode) surface. A crystallization reaction of the chemical precursors at 30-250° C. for 0-30 days, statically or under stirring conditions, can be used. The chemical precursors may include one or more of the following components: one a silica source, an alumina source, a mineralizing agent, acid or basic media, one or more templating agents or structure directing agents (SDAs).

In some embodiments, a separator may be prepared as a free-standing film. The free-standing film may be prepared in any number of ways. In one example, a free-standing film may be prepared by coating an inorganic particle separator onto a release layer which is then dissolved. The release layer may then be dissolved in an appropriate solvent. A free-standing film may also be produced by extruding a film that contains the inorganic particles and one or more binders (e.g., binding polymers). The one or more binders may include a binding polymer, such as polyethylene, polyvinyl chloride, polycarbonate, acrylonitrile butadiene styrene, polyvinylidene fluoride (PVDF), polytetrafluoroethylene (PTFE), polyvinyl alcohol, polyvinylpyrrolidone (PVP), polyacrylic acid (PAA), polyurethane (PU), polyvinyl acetate, polyvinyl chloride (PVC), carboxymethyl cellulose (CMC), hydroxypropyl cellulose (HPC), hydroxyethyl cellulose (HEC), or styrene butadiene rubber (SBR), or a combination thereof.

In some embodiments, a separator comprising inorganic particles and, optionally, one or more binders may be used in conjunction with a second separator, for example a second separator comprising inorganic particles and one or more binders, for example in an energy storage device such as a battery. The second separator may be placed in between two electrodes (e.g., an anode or a cathode), for example on an anode side of the first separator or the cathode side of the first separator, or both. Alternatively, the first separator may be disposed onto one or both sides of the second separator; the second separator may then be disposed between two electrodes.

In some embodiments, an inorganic particle separator may be applied to (e.g., coated on) or be a part of a current collector substrate. The inorganic particles mixtures may also comprise one, more, or a combination of polymers as binders, polymers as conductive additives, carbon as conductive additives, other conductive additives such as metals and metal oxides, and other additives necessary to stabilize the coating in an electrochemical environment.

Without wishing to be bound by any particular theory, inorganic particles in a separator may provide one or more of several functions. The particles may provide ionic conductivity, allowing the passage of ionic charge carriers to and from electrodes (e.g., an anode and cathode) (e.g., via an electrolyte), for example thereby promoting intercalation and deintercalation of ions in one or more electroactive materials in the electrodes. The conduction of ions can be facilitated by the presence of pores and polar sites on surface(s) (e.g., internal surface(s)) of inorganic particles. Additionally or alternatively, inorganic particles may act as an absorbent. Species from undesired side reactions may be collected in the inorganic particles, for example in pores and cage structures thereof. The inorganic particles may additionally or alternatively provide protection from undesired side reactions, including but not limited to irreversible surface reactions, loss of active material mass, corrosion, embrittlement, and pulverization. These reactions may occur within electrode(s), at surface(s) of the electrode(s), at surface(s) of current collector(s), or in a bulk of a current collector, for example. Reactants for one or more side reactions may exist in an electrolyte, for example by migrating from an electrode where they are formed.

In one such example, according to some embodiments, a silicate, a phosphate, a sulfate, an oxide, a hydride, or a combination thereof that form(s) part of a structure of inorganic particles may dissolve and precipitate as one or more polymeric species (e.g., polysilicate(s) and/or polyphosphate(s)) onto a surface of one or more materials in an energy storage device, rendering them passivated from undesired side reactions (e.g., further undesired side reactions). An energy storage device may include inorganic particles, for example in an electrode additive and/or separator, that include a silicate, a phosphate, a sulfate, an oxide, a hydride, or a combination thereof (e.g., one or more silicates and/or one or more phosphates). The silicate, phosphate, sulfate, oxide, hydride, or combination thereof (e.g., silicate(s) and/or phosphate(s)) may be in a stable (e.g., salt) and/or ionic (e.g., anionic) form. The silicate, phosphate, sulfate, oxide, hydride, or combination thereof (e.g., silicate(s) and/or phosphate(s)) may be reacted with one or more species (e.g., in an electrolyte and/or electrode) (e.g., one or more moieties of the species); the one or more species may be reactant(s) in one or more undesired side reactions for the energy storage device. In some embodiments, the reacting includes dissolving at least a portion of the inorganic particles. After reaction, one or more reaction products may passivate a surface of a material in the energy storage device, for example a metallic surface and/or a surface of an electroactive material. The surface may be passivated by forming or depositing one or more polymeric species (e.g., including a polysilicate and/or a polyphosphate) onto the surface. The passivated surface may therefore prevent one or more undesired side reactions from occurring or further occurring. The reacting and/or passivating may occur during electrochemical cycling of the energy storage device (e.g., during charge and/or discharge of a battery) or before completing assembly of the energy storage device (e.g., during a preconditioning process of an electrode of the energy storage device).

Multiple embodiments of these inorganic particles may be included in a separator, for example inorganic particles with a surface area less than 10 m2/g interspersed amongst particles with a surface area greater than 100 m2/g. In one embodiment, a separator comprised of these inorganic particles can resist puncture by dendrites formed on an adjacent electrode. In a further embodiment, a protective separator layer is formed on the surface of a first electrode before assembling the first electrode into a cell opposite a second electrode comprised of a metal. In an even further embodiment, the separator physically compresses the second electrode, minimizing the growth of the dendrites and preventing the penetration of the dendrites through the separator to the first electrode.

### Additives

In some embodiments, an additive for an energy storage device (e.g., electrochemical cell) includes inorganic particles. The additive may be used in an electrode (e.g., an anode and/or a cathode of an electrochemical cell). The electrode includes an electroactive material and, optionally, may also include, in addition to the electroactive material and the inorganic particles, one or more binders to bind the inorganic particles together, one or more conductive additives, or both. The inorganic particles may be functional inorganic particles. One or more additives can be included in an electrode during fabrication of the electrode. In some embodiments, an electrode is prepared by coating a mixture (e.g., solution) that includes one or more additives and one or more electroactive materials, for example onto a substrate, such as a current collector. The following description provides, inter alia, inorganic particles of different types (e.g., different compositions, sizes, morphologies, porosity, or combination thereof). An additive may include inorganic particles of only one type or of different types mixed together.

In some embodiments, inorganic particles are at least 50 wt. % (e.g., at least 60 wt. %, at least 70 wt. %, at least 80 wt. %, at least 90 wt. %, or at least 95 wt. %) of an additive. Inorganic particles may include oxygen, hydrogen, aluminum, silicon, phosphorous, a metal atom, or a combination thereof. Usable metal atoms include aluminum, silicon, lithium, sodium, potassium, rubidium, cesium, beryllium, magnesium, calcium, strontium, barium, boron, gallium, indium, thallium, carbon, germanium, tin, lead, nitrogen, phosphorous, arsenic, antimony, bismuth, scandium, titanium, vanadium, chromium, manganese, iron, cobalt, nickel, copper, zinc, yttrium, zirconium, niobium, molybdenum, ruthenium, rhodium, palladium, silver, cadmium, hafnium, tantalum, tungsten, rhenium, osmium, iridium, platinum, gold, mercury, lanthanum, cerium, praseodymium, neodymium, samarium, europium, gadolinium, terbium, dysprosium, holmium, erbium, thulium, ytterbium, lutetium, actinium, thorium, protactinium, uranium, neptunium, and plutonium. One or more elements comprised in inorganic particles may be at least 10 wt. % (e.g., at least 20 wt. %, at least 30 wt. %, or at least 50 wt. %) of the inorganic particles. Alternatively or additionally, one or more metal atoms comprised in inorganic particles may be no more than 80 wt. % (e.g., no more than 50 wt. %, no more than 30 wt. %, no more than 20 wt. %) of the inorganic particles. Inorganic particles may have a composition of M_{y}AlₓSi₁₋ₓO₂·zH₂O, where M is a metal. X may be in a range of 0 to 0.5 (e.g., 0 to 0.1 or from 0.01 to 0.5) while y is in a range of 0 to 0.5 (e.g., 0 to 0.1). X may be in a range of from 0.5 to 1 while y is in a range of 0 to 1. Z may be in a range of 0 to 10,000.

Inorganic particles may be crystalline, amorphous, or a combination thereof. Inorganic particles may have an average particle size (D₅₀) in a range of 100 nm-30 μm. Inorganic particles may have a shape of spheres, rods, needles, flakes, platelets, cubes, discs, or tubes. In some embodiments, inorganic particles of an electrode additive are from 1 vol. % to 50 vol. % (e.g., from 5 vol. % to 30 vol. % or from 10 vol. % to 20 vol. %) of an electrode active layer (e.g., coating or film) of an electrode (e.g., excluding any current collector), preferably from 5 vol. % to 30 vol. %, more preferably from 10 vol. % to 20 vol. %.

Inorganic particles may be porous. The porosity can be microporosity, mesoporosity, macroporosity, or a combination thereof. Inorganic particles may include one or more pores that are less than 2 nm in size (e.g., diameter). Inorganic particles may include one or more pores that of at least 2 nm and no more than 50 nm in size (e.g., diameter). Inorganic particles may include one or more pores that are more than 50 nm in size (e.g., diameter). In some embodiments, inorganic particles include one or more pores having a size (e.g., diameter) in a range of from 1 Å to 20 Å (e.g., from 1 Å to 10 Å, from 3 Å to 8 Å, from 4 Å to 5 Å) [e.g., from 1.5 Å (e.g., 1.56 Å) to 16.5 Å (e.g., 16.45 Å)]. Inorganic particles may have a surface area of at least 10 m²/g (e.g., at least 100 m²/g, at least 250 m²/g, at least 300 m²/g, at least 500 m²/g, or at least 700 m²/g), for example as a result of their porosity.

One or more pores of an inorganic particle may connect to form one or more channels. The one or more channels of one or more inorganic particles may intersect to form one or more channel systems, for example extending through particle, or in some embodiments through an electrode (e.g., through multiple particles). A channel system may be a 1-, 2- or 3-dimensional channel system. FIG. 1A illustrates an example of one dimensional pores that form a one dimensional channel system through a particle. FIG. 1A illustrates an example of two dimensional pores that form a two dimensional channel system. While the pores are shown as straight in FIGS. 1A-1B, this need not necessarily be; pores can follow complex (non-linear) paths into and/or through a particle. (FIGS. 1A-1B do not illustrate a three-dimensional channel system, which would include pores in a third dimension (into and out of the page with respect to FIG. 1B, for example.) In some embodiments, one or more cage structures exist at the intersection of two or more pores. A cage structure can be located at an intersection of pores. A cage structure can be located within one or more 1-dimensional pores. FIG. 1C illustrates an example of cage structures located within one or more 1-dimensional pores.

In certain embodiments, one or more pores and/or one or more cage structures have one or more species disposed therein. For example, one or more species may be absorbed into one or more pores and/or one or more cage structures and not covalently bound to the inorganic particles. One or more species disposed in a pore and/or cage structure may be, for example, adsorbed onto a surface of the pore and/or cage structure (e.g., an interior surface or an opening), absorbed into the pore and/or cage structure, or both. The size, shape, dimensionality, and hydrophobicity/hydrophilicity environment of the pore(s) and/or cage structures may determine which one or more species may be suitable for, contained in, and/or absorbed in such pores. For example, larger pores may be used to accommodate a larger species while a smaller pore is used for a smaller species. Similarly, an additive may include a first type of inorganic particles that include hydrophobic pores may have a hydrophobic species adsorbed thereon and a second type of inorganic particles that include hydrophilic (or less hydrophobic) pores may have a hydrophilic (or less hydrophobic) species adsorbed thereon. The hydrophobicity/hydrophilicity environment of inorganic particles can be tuned, for example, via modification of chemical composition of the particles and/or via surface treatment. Incorporation of different species (e.g., different atomic and/or ionic species) can change overall polarity of a surface and thus the hydrophobicity/hydrophilicity.

One or more species that are disposed in one or more pores and/or one or more cage structures may be or include water, olefinic hydrocarbons, paraffinic hydrocarbons, naphthenic hydrocarbons, aromatic hydrocarbons, or a combination thereof. One or more gas species may be included in (e.g., on a surface of) one or more pores and/or one or more cage structures. The one or more gas species may include hydrogen, oxygen, a carbon oxide (e.g., carbon dioxide), nitrogen, argon, hydrogen disulfide, ammonia, nitric oxide, a nitrogen oxide (e.g., nitrogen dioxide), a sulfur oxide (e.g., sulfur dioxide), or a combination thereof. One or more cationic species may be included in (e.g., on a surface of) one or more pores and/or one or more cage structures. The one or more cationic species may include a cationic form of lithium, sodium, potassium, rubidium, cesium, beryllium, magnesium, calcium, strontium, barium, boron, aluminum, gallium, indium, thallium, carbon, germanium, tin, lead, nitrogen, phosphorous, arsenic, antimony, bismuth, scandium, titanium, vanadium, chromium, manganese, iron, cobalt, nickel, copper, zinc, yttrium, zirconium, niobium, molybdenum, ruthenium, rhodium, palladium, silver, cadmium, hafnium, tantalum, tungsten, rhenium, osmium, iridium, platinum, gold, mercury, lanthanum, cerium, presidium, neodymium, samarium, europium, gadolinium, terbium, dysprosium, holmium, erbium, thulium, ytterbium, lutetium, actinium, thorium, protactinium, uranium, neptunium, plutonium, or a combination thereof. One or more anionic species can be located in (e.g., disposed on a surface of) one or more cage structures and/or one or more pores. The one or more anionic species may include polyatomic anions. The one or more anionic species may include a hydroxide, an alkoxide, a peroxide, a superoxide, a nitrate, a nitrite, a sulfate, a sulfite, a phosphate, a phosphide, a fluoride, a chloride, a bromide, an iodide, a chlorate, a bromate, an iodate, a polyoxymetalates, or a combination thereof. Suitable methods for inserting and substituting species into pore(s) and/or cage structure(s) of inorganic particles are known to those of ordinary skill in the art.

An example of an inorganic particle (e.g., a functional inorganic particle) is a structure having a general chemical composition M_{y}AlₓSi₁₋ₓO₂·zH₂O, where x is in the range of 0 to 0.1, y is in the range of 0 to 0.1, and z is in the range of 0 to 10,000. M may be any one or more of the following: Li (lithium), Na (sodium), K (potassium), Rb (rubidium), Cs (cesium), Be (beryllium), Mg (magnesium), Ca (calcium), Sr (strontium), Ba (barium), B (boron), Ga (gallium), In (indium), Tl (thallium), C (carbon), Ge (germanium), Sn (tin), Pb (lead), N (nitrogen), P (phosphorous), As (arsenic), Sb (antimony), Bi (bismuth), Sc (scandium), Ti (titanium), V (vanadium), Cr (chromium), Mn (manganese), Fe (iron), Co (cobalt), Ni (nickel), Cu (copper), Zn (zinc), Y (yttrium), Zr (zirconium), Nb (niobium), Mo (molybdenum), Ru (ruthenium), Rh (rhodium), Pd (palladium), Ag (silver), Cd (cadmium), Hf (hafnium), Ta (tantalum), W (tungsten), Re (rhenium), Os (osmium), Ir (iridium), Pt (platinum), Au (gold), Hg (mercury), La (lanthanum), Ce (cerium), Pr (praseodymium), Nd (neodymium), Sm (samarium), Eu (europium), Gd (gadolinium), Tb (terbium), Dy (dysprosium), Ho (holmium), Er (erbium), Th (thulium), Yb (ytterbium), Lu (lutetium), Ac (actinium), Th (thorium), Pa (protactinium), U (uranium), Np (neptunium), Pu (plutonium). This inorganic particle has three-dimensional interconnected pore structures defining a three-dimensional channel system. These pores have openings that range in size from 1-10 Å, preferably between 3 Å and 8 Å, and more preferably between 4 Å and 5 Å. These three-dimensional pores intersect to create cage structures with a diameter in the range of 1 Å and 10 Å, preferably between 3 Å and 8 Å, and more preferably between 6 Å and 7 Å. These inorganic particles typically have surface areas of at least 10 m²/g, preferably at least 100 m²/g, and more preferably at least 300 m²/g. A plurality of these inorganic particles can be included in an additive or electrode, for example bound together with one or more binders in the electrode.

Another example of an inorganic particle (e.g., a functional inorganic particle) is a structure having a general chemical composition M_{y}AlₓSi₁₋ₓO₂·zH₂O, where x is in the range of 0 to 0.5, y is in the range of 0 to 0.5 and z is in the range of 0 to 10,000. M may be any one or more of the following: Li (lithium), Na (sodium), K (potassium), Rb (rubidium), Cs (cesium), Be (beryllium), Mg (magnesium), Ca (calcium), Sr (strontium), Ba (barium), B (boron), Ga (gallium), In (indium), Tl (thallium), C (carbon), Ge (germanium), Sn (tin), Pb (lead), N (nitrogen), P (phosphorous), As (arsenic), Sb (antimony), Bi (bismuth), Sc (scandium), Ti (titanium), V (vanadium), Cr (chromium), Mn (manganese), Fe (iron), Co (cobalt), Ni (nickel), Cu (copper), Zn (zinc), Y (yttrium), Zr (zirconium), Nb (niobium), Mo (molybdenum), Ru (ruthenium), Rh (rhodium), Pd (palladium), Ag (silver), Cd (cadmium), Hf (hafnium), Ta (tantalum), W (tungsten), Re (rhenium), Os (osmium), Ir (iridium), Pt (platinum), Au (gold), Hg (mercury), La (lanthanum), Ce (cerium), Pr (praseodymium), Nd (neodymium), Sm (samarium), Eu (europium), Gd (gadolinium), Tb (terbium), Dy (dysprosium), Ho (holmium), Er (erbium), Th (thulium), Yb (ytterbium), Lu (lutetium), Ac (actinium), Th (thorium), Pa (protactinium), U (uranium), Np (neptunium), Pu (plutonium). This inorganic particle has three-dimensional interconnected pores defining a three-dimensional channel system. These pores have openings that range in size from 1-10 Å, preferably between 3 Å and 8 Å, and more preferably between 7 Å and 8 Å. These three-dimensional pores intersect to create cage structures with a diameter in the range of 1 Å and 20 Å, preferably between 5 Å and 15 Å, and more preferably between 11 Å and 12 Å. These inorganic particles typically have surface areas of at least 10 m²/g, preferably at least 250 m²/g, and more preferably at least 700 m²/g. A plurality of these inorganic particles can be included in an additive, for example in an electrode, optionally bound together with one or more binders.

Another example of an inorganic particle (e.g., a functional inorganic particle) is a structure having a general chemical composition of M_{y}AlₓSi₁₋ₓO₂·zH₂O, where x is in the range of 0.5-1, y is in the range of 0-1 and z is in the range of 0-10,000. M may be any one or more of the following: Li (lithium), Na (sodium), K (potassium), Rb (rubidium), Cs (cesium), Be (beryllium), Mg (magnesium), Ca (calcium), Sr (strontium), Ba (barium), B (boron), Ga (gallium), In (indium), Tl (thallium), C (carbon), Ge (germanium), Sn (tin), Pb (lead), N (nitrogen), P (phosphorous), As (arsenic), Sb (antimony), Bi (bismuth), Sc (scandium), Ti (titanium), V (vanadium), Cr (chromium), Mn (manganese), Fe (iron), Co (cobalt), Ni (nickel), Cu (copper), Zn (zinc), Y (yttrium), Zr (zirconium), Nb (niobium), Mo (molybdenum), Ru (ruthenium), Rh (rhodium), Pd (palladium), Ag (silver), Cd (cadmium), Hf (hafnium), Ta (tantalum), W (tungsten), Re (rhenium), Os (osmium), Ir (iridium), Pt (platinum), Au (gold), Hg (mercury), La (lanthanum), Ce (cerium), Pr (praseodymium), Nd (neodymium), Sm (samarium), Eu (europium), Gd (gadolinium), Tb (terbium), Dy (dysprosium), Ho (holmium), Er (erbium), Th (thulium), Yb (ytterbium), Lu (lutetium), Ac (actinium), Th (thorium), Pa (protactinium), U (uranium), Np (neptunium), Pu (plutonium). This inorganic particle has three-dimensional interconnected pore structures defining a three-dimensional channel system. These pores have openings that range in size from 1-10 Å, preferably between 3 Å and 8 Å, and more preferably between 4 Å and 5 Å. These three-dimensional pores intersect to create cage structures with a diameter in the range of 1 Å and 20 Å, preferably between 5 Å and 15 Å, and more preferably between 10 Å and 12 Å. These inorganic particles typically have surface areas of at least 10 m²/g, preferably at least 250 m²/g, and more preferably at least 500 m²/g. A plurality of these inorganic particles can be included in an additive, for example in an electrode, optionally bound together with one or more binders.

Another example of an inorganic particle (e.g., a functional inorganic particle) is a structure having a general chemical composition of M_{y}AlₓSi₁₋ₓO₂·zH₂O, where x is in the range of 0.01 to 0.5 and y is in the range of 0-0.5, and z is in the range of 0-10,000. M may be any one or more of the following: Li (lithium), Na (sodium), K (potassium), Rb (rubidium), Cs (cesium), Be (beryllium), Mg (magnesium), Ca (calcium), Sr (strontium), Ba (barium), B (boron), Ga (gallium), In (indium), Tl (thallium), C (carbon), Ge (germanium), Sn (tin), Pb (lead), N (nitrogen), P (phosphorous), As (arsenic), Sb (antimony), Bi (bismuth), Sc (scandium), Ti (titanium), V (vanadium), Cr (chromium), Mn (manganese), Fe (iron), Co (cobalt), Ni (nickel), Cu (copper), Zn (zinc), Y (yttrium), Zr (zirconium), Nb (niobium), Mo (molybdenum), Ru (ruthenium), Rh (rhodium), Pd (palladium), Ag (silver), Cd (cadmium), Hf (hafnium), Ta (tantalum), W (tungsten), Re (rhenium), Os (osmium), Ir (iridium), Pt (platinum), Au (gold), Hg (mercury), La (lanthanum), Ce (cerium), Pr (praseodymium), Nd (neodymium), Sm (samarium), Eu (europium), Gd (gadolinium), Tb (terbium), Dy (dysprosium), Ho (holmium), Er (erbium), Th (thulium), Yb (ytterbium), Lu (lutetium), Ac (actinium), Th (thorium), Pa (protactinium), U (uranium), Np (neptunium), Pu (plutonium). This inorganic particle has a three-dimensional interconnected pore structures defining a three-dimensional channel system. These pores have openings that range in size from 1-10 Å, preferably between 2 Å and 6 Å, and more preferably between 3 Å and 4 Å. These three-dimensional pores intersect to create cage structures with a diameter in the range of 1 Å and 20 Å, preferably between 5 Å and 15 Å, and more preferably between 7 Å and 8 Å. These inorganic particles typically have surface areas of at least 10 m²/g, preferably at least 250 m²/g, and more preferably at least 500 m²/g. A plurality of these inorganic particles can be included in an additive, for example in an electrode, optionally bound together with one or more binders.

Another example of an inorganic particle (e.g., a functional inorganic particle) is a structure having a general chemical composition M_{y}AlₓSi₁₋ₓO₂·zH₂O, where x is in the range of 0.01 to 0.5, y is in the range of 0 to 0.5, and z is in the range of 0-10,000. M may be any one or more of the following: Li (lithium), Na (sodium), K (potassium), Rb (rubidium), Cs (cesium), Be (beryllium), Mg (magnesium), Ca (calcium), Sr (strontium), Ba (barium), B (boron), Ga (gallium), In (indium), Tl (thallium), C (carbon), Ge (germanium), Sn (tin), Pb (lead), N (nitrogen), P (phosphorous), As (arsenic), Sb (antimony), Bi (bismuth), Sc (scandium), Ti (titanium), V (vanadium), Cr (chromium), Mn (manganese), Fe (iron), Co (cobalt), Ni (nickel), Cu (copper), Zn (zinc), Y (yttrium), Zr (zirconium), Nb (niobium), Mo (molybdenum), Ru (ruthenium), Rh (rhodium), Pd (palladium), Ag (silver), Cd (cadmium), Hf (hafnium), Ta (tantalum), W (tungsten), Re (rhenium), Os (osmium), Ir (iridium), Pt (platinum), Au (gold), Hg (mercury), La (lanthanum), Ce (cerium), Pr (praseodymium), Nd (neodymium), Sm (samarium), Eu (europium), Gd (gadolinium), Tb (terbium), Dy (dysprosium), Ho (holmium), Er (erbium), Th (thulium), Yb (ytterbium), Lu (lutetium), Ac (actinium), Th (thorium), Pa (protactinium), U (uranium), Np (neptunium), Pu (plutonium). This inorganic particle comprises one-dimensional pores. These pores have openings that range in size from 1-10 Å, preferably between 1 Å and 8 Å, and more preferably between 1 Å and 7 Å. These inorganic particles typically have surface areas of at least 10 m²/g, preferably at least 150 m²/g, and more preferably at least 300 m²/g. A plurality of these inorganic particles can be included in an additive, for example in an electrode, optionally bound together with one or more binders.

Another example of an inorganic particle (e.g., a functional inorganic particle) is a structure having a general chemical composition M_{y}AlₓSi₁₋ₓO₂·zH₂O, where x is in the range of 0.01 to 0.5, y is in the range of 0 to 0.5 and z is in the range of 0 to 10,000. M may be any one of the following Li (lithium), Na (sodium), K (potassium), Rb (rubidium), Cs (cesium), Be (beryllium), Mg (magnesium), Ca (calcium), Sr (strontium), Ba (barium), B (boron), Ga (gallium), In (indium), Tl (thallium), C (carbon), Ge (germanium), Sn (tin), Pb (lead), N (nitrogen), P (phosphorous), As (arsenic), Sb (antimony), Bi (bismuth), Sc (scandium), Ti (titanium), V (vanadium), Cr (chromium), Mn (manganese), Fe (iron), Co (cobalt), Ni (nickel), Cu (copper), Zn (zinc), Y (yttrium), Zr (zirconium), Nb (niobium), Mo (molybdenum), Ru (ruthenium), Rh (rhodium), Pd (palladium), Ag (silver), Cd (cadmium), Hf (hafnium), Ta (tantalum), W (tungsten), Re (rhenium), Os (osmium), Ir (iridium), Pt (platinum), Au (gold), Hg (mercury), La (lanthanum), Ce (cerium), Pr (praseodymium), Nd (neodymium), Sm (samarium), Eu (europium), Gd (gadolinium), Tb (terbium), Dy (dysprosium), Ho (holmium), Er (erbium), Th (thulium), Yb (ytterbium), Lu (lutetium), Ac (actinium), Th (thorium), Pa (protactinium), U (uranium), Np (neptunium), and Pu (plutonium). This inorganic particle has two-dimensional interconnected pore structures. These pores have openings that range in size from 1-10 Å, preferably between 1 Å and 8 Å, and more preferably between 1 Å and 5 Å. These two-dimensional pores intersect to create cage structures with a diameter in the range of 1 Å and 20 Å, preferably between 5 Å and 15 Å, and more preferably between 5 Å and 7 Å. These inorganic particles typically have surface areas of at least 10 m²/g, preferably at least 150 m²/g, and more preferably at least 300 m²/g. A plurality of these inorganic particles can be included in an additive, for example in an electrode, optionally bound together with one or more binders.

Inorganic particles may be prepared via crystallization reaction of chemical precursors at 30-250° C. for 0-30 days, statically or under stirring conditions. The chemical precursors may include one or more of the following components: one a silica source, an alumina source, a mineralizing agent, acid or basic media, one or more templating agents or structure directing agents (SDAs).

One or more inorganic particles of an electrode additive may be added directly to a mixture (e.g., solution and/or coating formulation) used to dispose an electrode active layer onto a current collector in order to form an electrode. The mixture may contain any combination of one or more electroactive materials, one or more conductive additives, one or more binders and one or more additives. Examples of electroactive materials that may be used in an electrode include the following: oxides, suboxides, sulfides, oxysulfides, phosphates, phosphides and carbides, and elemental forms of silicon, vanadium, niobium, molybdenum, rhenium, tantalum, tungsten, bismuth, titanium, tin, antimony, manganese, nickel, aluminum, lithium, sodium, potassium, calcium, zinc, cobalt, chromium, indium, lanthanum, cerium, strontium, and iron, and combinations thereof. An electroactive material of an electrode may be modified (e.g., doped) using one or more elements. The one or more elements may be any of the following: hydrogen, lithium, boron, carbon, nitrogen, oxygen, sulfur, sodium, magnesium, aluminum, silicon, potassium, calcium, titanium, vanadium, chromium, manganese, iron, cobalt, nickel, copper, zinc, gallium, germanium, rubidium, strontium, zirconium, niobium, molybdenum, ruthenium, silver, cadmium, indium, tin, antimony, lanthanum, cerium, neodymium, tantalum, tungsten, rhenium, platinum, gold, lead, bismuth. An electrode active layer that includes one or more electroactive materials and one or more additives may be a free-standing film or may be present (e.g., coated) on a substrate, such as a current collector. The substrate may include carbon materials such as foams, papers, aerogels, foils, fibers, or nanostructures (e.g., nanoparticles), or metal foils, foams, sheets, meshes, or stock.

In some embodiments, an electrode for an energy storage device includes one more binders. Each of the one or more binders may be, for example, polyvinylidene fluoride (PVDF), polytetrafluoroethylene (PTFE), polyvinyl alcohol, polyvinylpyrrolidone (PVP), polyvinyl acetate, polyacrylic acid (PAA), polyvinyl chloride (PVC), carboxymethyl cellulose (CMC), hydroxypropyl cellulose (HPC), hydroxyethyl cellulose (HEC), styrene butadiene rubber (SBR), or a copolymer thereof. In some embodiments, an electrode for an energy storage device includes one or more conductive additives in addition to one or more additives comprising inorganic particles. Each of the one or more conductive additives may be selected from the following: carbon black, acetylene black, carbon fibers, carbon nanotubes, graphene, graphite, fullerenes, carbon aerogels, metal flakes, metal fibers, metal particles, and conductive polymers. A conductive polymer used in an electrode in an energy storage device may be, for example, polyaniline, polyacetylene, polyphenylene vinylene, polypyrrole, polythiophene, polyphenylene sulfide, polyfluorenes, polypyrenes, polyazulenes, polynapthalenes, poly(p-phenylene vinylene), poly(p-phenylene sulfide), or PEDOT.

Inorganic particles of an electrode additive may be disposed on a surface of an electroactive material. For example, the inorganic particles may be disposed on one or more surfaces of micro- and/or nano-structures formed by the electroactive material, such as particles (of any shape, such as spheres or rods), films, tubes, and/or fibers. Inorganic particles of an electrode additive may be disposed on a surface of a conductive additive. For example, the inorganic particles may be disposed on one or more surfaces of micro- and/or nano-structures formed by the conductive additive, such as particles (of any shape, such as spheres or rods), films, tubes, and/or fibers.

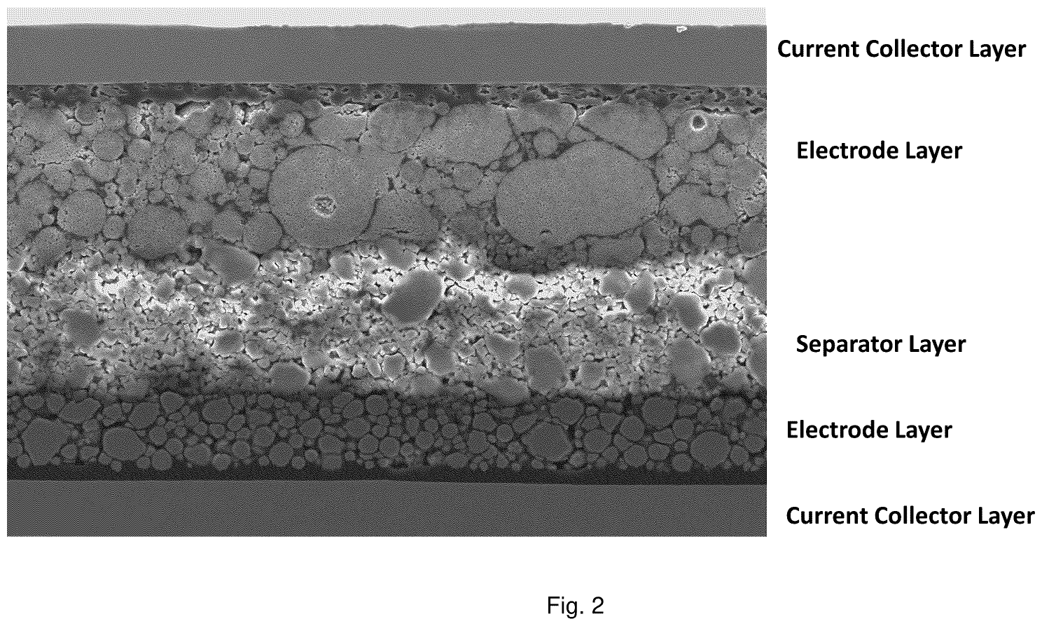

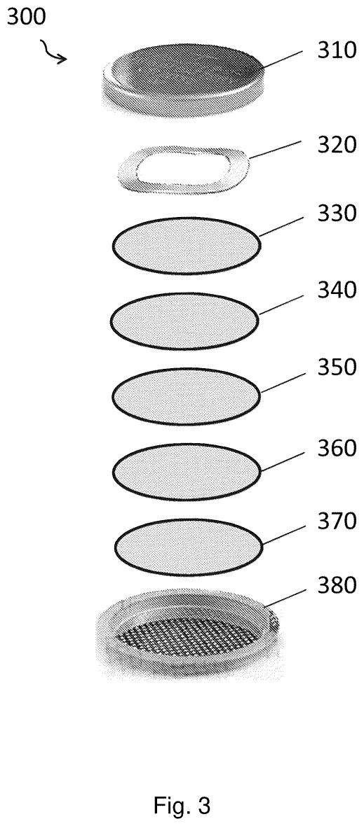

In some embodiments, inorganic particles of an additive in an electrode may form a core-shell structure with an electroactive material, for example where the electroactive material exists as particles (e.g., micro- and/or nano-particles) and the inorganic particles are disposed on the electroactive material particles. Inorganic particles may form a layer of uniform or non-uniform thickness on (e.g., entirely around) electroactive material (e.g., electroactive material particles). FIG. 2 is a cross-section of a battery having such an arrangement where both electrodes layers (anode and cathode) and a separator layer includes particles (e.g., additives) as disclosed herein. In some embodiments, an energy storage device in accordance with the present disclosure may be a battery, for example, having a standard 2023 coin cell form factor as illustrated in FIG. 3. In some embodiments, a battery may include a first electrode, a second electrode, and a separator as disclosed herein disposed therebetween. For example, in FIG. 3, battery 300 includes a top 310, a spring 320, a first spacer 330, a cathode 340, a separator 350 (e.g., as disclosed herein), an anode 360, a second spacer 370, an electrolyte (not labeled), and a base 380. Other form factors for batteries having the same or similar components may also be used, as discussed further subsequently. In some embodiments, a thickness of a layer of inorganic materials of an additive is no more than 2 μm.

Inorganic particles may be adhered to a surface of an electroactive material by electrostatic potential. Such electrostatic potential can result when the inorganic particles and the electroactive material has opposite charge. Inorganic particles and electroactive material (e.g., electroactive particles) may be dry-blended or combined in aqueous slurry. One or more surfactants and one or more surface modifiers known to those familiar in the art may be used to alter surface chemistry of electroactive material or inorganic particles in order to achieve the desired electrostatic potential. Alternatively or additionally, inorganic particles may be deposited on a surface of an electroactive material via chemical reaction. Sol-gel synthesis is an example of a method that may be used to deposit inorganic particles onto a surface of an electroactive material. In some embodiments, inorganic particles may be evenly distributed throughout an active layer of an electrode, for example that is deposited onto a current collector. For example, additive inorganic particles and electroactive material particles may be dispersed throughout an electrode (e.g., an active layer thereof).

Without wishing to be bound by any particular theory, the inorganic particles in an additive in an electrode may provide one or more of several functions. The inorganic particles may provide ionic conductivity, allowing the passage of non-electron charge carriers to and from one or more electroactive materials, for example thereby promoting intercalation and deintercalation of ions in the electroactive material(s). The conduction of ions can be facilitated by presence of pores and polar sites on one or more surfaces of the inorganic particles in the additive. Such increased conduction can improve cell performance by reducing resistance of an electrochemical cell and/or improving quantum efficiency of the electrochemical cell. Alternatively or additionally, inorganic particles in an additive may act as an absorbent. One or more species from one or more undesired side reactions may be collected in the inorganic particles (e.g., in pores thereof). Sequestering these byproducts maintains integrity of an energy storage device, for example by preventing poisoning of one or more electrodes in which the additive(s) are added. This improves overall cycle life of an energy storage device. Inorganic particles may also provide protection from undesired side reactions, including but not limited to irreversible surface reactions, loss of active material mass, corrosion, embrittlement, pulverization. These reactions may occur within one or more electrodes, at one or more surfaces of one or more electrodes, at one or more surfaces of one or more current collectors, or in a bulk of a current collector. Preventing one or more undesired side reactions can help maintain quantum efficiency and overall performance of an energy storage device.

In one such example, according to some embodiments, a silicate, a phosphate, a sulfate, an oxide, a hydride, or a combination thereof that form(s) part of a structure of inorganic particles may dissolve and precipitate as one or more polymeric species (e.g., polysilicate(s) and/or polyphosphate(s)) onto a surface of one or more materials in an energy storage device, rendering them passivated from undesired side reactions (e.g., further undesired side reactions). An energy storage device may include inorganic particles, for example in an electrode additive and/or separator, that include a silicate, a phosphate, a sulfate, an oxide, a hydride, or a combination thereof (e.g., one or more silicates and/or one or more phosphates). The silicate, phosphate, sulfate, oxide, hydride, or combination thereof (e.g., silicate(s) and/or phosphate(s)) may be in a stable (e.g., salt) and/or ionic (e.g., anionic) form. The silicate, phosphate, sulfate, oxide, hydride, or combination thereof (e.g., silicate(s) and/or phosphate(s)) may be reacted with one or more species (e.g., in an electrolyte and/or electrode) (e.g., one or more moieties of the species); the one or more species may be reactant(s) in one or more undesired side reactions for the energy storage device. In some embodiments, the reacting includes dissolving at least a portion of the inorganic particles. After reaction, one or more reaction products may passivate a surface of a material in the energy storage device, for example a metallic surface and/or a surface of an electroactive material. The surface may be passivated by forming or depositing one or more polymeric species (e.g., including a polysilicate and/or a polyphosphate) onto the surface. The passivated surface may therefore prevent one or more undesired side reactions from occurring or further occurring. The reacting and/or passivating may occur during electrochemical cycling of the energy storage device (e.g., during charge and/or discharge of a battery) or before completing assembly of the energy storage device (e.g., during a preconditioning process of an electrode of the energy storage device).

### Additional Separator and Additive Materials: Organic Ligands, Non-Metallic Oxides, and Partially Reduced Carbons (Graphite and Graphene)

A separator may include a functional material. A functional material may be used as an additive in an energy storage device, for example in an electrode of a battery, such as a secondary battery. The functional material may include one or more organic ligands. Additionally or alternatively, the functional material may include one or more non-metallic oxides. Additionally or alternatively, the functional material may include a partially reduced carbon, for example a partially reduced graphene, a partially reduced graphite, or both.

The functional material may be modified with (e.g., doped with) one or more elements. The one or more elements may be one or more of the following: sodium, potassium, calcium, barium, cesium, scandium, cadmium, magnesium, iron, manganese, lithium, zinc, zirconium, niobium, yttrium, molybdenum, hafnium, osmium, nickel, cobalt, germanium, beryllium, mercury, tungsten, platinum, rubidium, ruthenium, rhodium, palladium, antimony, tellurium, bismuth, arsenic, lead, lanthanum, europium, gadolinium, cerium, tin, chromium, vanadium, titanium, aluminum, tantalum, gallium, indium, silver, gold, copper, carbon, hydrogen, boron, oxygen, nitrogen, fluorine, chlorine, bromine, and iodine. The functional material may additionally comprise one or more water molecules. For example, the one or more water molecules may be coordinated and/or bonded, for example hydrogen bonded, to the functional material (e.g., a backbone ligand in the case of one or more ligands being included in the functional material or the partially reduced carbon in the case of a partially reduced carbon being included in the functional material).

In some embodiments, a functional material is porous. The porosity can be microporosity, mesoporosity, macroporosity, or a combination thereof. A functional material may include one or more pores that are less than 2 nm in size (e.g., diameter). A functional material may include one or more pores that of at least 2 nm and no more than 50 nm in size (e.g., diameter). A functional material may include one or more pores that are more than 50 nm in size (e.g., diameter). In some embodiments, a functional material includes one or more pores having a size (e.g., diameter) in a range of from 1 Å to 20 Å (e.g., from 1 Å to 10 Å, from 3 Å to 8 Å, from 4 Å to 5 Å) [e.g., from 1.5 Å (e.g., 1.56 Å) to 16.5 Å (e.g., 16.45 Å)]. A functional material may have a surface area of at least 10 m²/g (e.g., at least 100 m²/g, at least 250 m²/g, at least 300 m²/g, at least 500 m²/g, or at least 700 m²/g), for example as a result of its porosity and/or structure (e.g., if in the form of particles).

One or more pores of an functional material may connect to form one or more channels. The one or more channels of one or more portions of a functional material may intersect to form one or more channel systems, for example extending through a separator. A channel system may be a 1-, 2- or 3-dimensional channel system.

In certain embodiments, one or more pores have one or more species disposed therein. For example, one or more species may be absorbed into one or more pores and not covalently bound to the inorganic particles. One or more species disposed in a pore and/or cage structure may be, for example, adsorbed onto a surface of the pore and/or cage structure (e.g., an interior surface or an opening), absorbed into the pore and/or cage structure, or both. The size, shape, dimensionality, and hydrophobicity/hydrophilicity environment of the pore(s) and/or cage structures may determine which one or more species may be suitable for, contained in, and/or absorbed in such pores. For example, larger pores may be used to accommodate a larger species while a smaller pore is used for a smaller species. Similarly, a separator may include a first type of inorganic particles that include hydrophobic pores may have a hydrophobic species adsorbed thereon and a second type of inorganic particles that include hydrophilic (or less hydrophobic) pores may have a hydrophilic (or less hydrophobic) species adsorbed thereon. The hydrophobicity/hydrophilicity environment of inorganic particles can be tuned, for example, via modification of chemical composition of the particles and/or via surface treatment. Incorporation of different species (e.g., different atomic and/or ionic species) can change overall polarity of a surface and thus the hydrophobicity/hydrophilicity.

One or more species that are disposed in one or more pores may be or include water, olefinic hydrocarbons, paraffinic hydrocarbons, naphthenic hydrocarbons, aromatic hydrocarbons, or a combination thereof. One or more gas species may be included in (e.g., on a surface of) one or more pores. The one or more gas species may include hydrogen gas, oxygen gas, carbon dioxide gas, nitrogen gas, argon gas, hydrogen disulfide gas, ammonia gas, nitric oxide, nitrogen dioxide, sulfur dioxide, or a combination thereof. One or more cationic species may be included in (e.g., on a surface of) one or more pores. The one or more cationic species may include a cationic form of lithium, sodium, potassium, rubidium, cesium, beryllium, magnesium, calcium, strontium, barium, boron, aluminum, gallium, indium, thallium, carbon, germanium, tin, lead, nitrogen, phosphorous, arsenic, antimony, bismuth, scandium, titanium, vanadium, chromium, manganese, iron, cobalt, nickel, copper, zinc, yttrium, zirconium, niobium, molybdenum, ruthenium, rhodium, palladium, silver, cadmium, hafnium, tantalum, tungsten, rhenium, osmium, iridium, platinum, gold, mercury, lanthanum, cerium, presidium, neodymium, samarium, europium, gadolinium, terbium, dysprosium, holmium, erbium, thulium, ytterbium, lutetium, actinium, thorium, protactinium, uranium, neptunium, plutonium, or a combination thereof. One or more anionic species can be located in (e.g., disposed on a surface of) one or more cage structures and/or one or more pores. The one or more anionic species may include polyatomic anions. The one or more anionic species may include a hydroxide, an alkoxide, a peroxide, a superoxide, a nitrate, a nitrite, a sulfate, a sulfite, a phosphate, a phosphide, a fluoride, a chloride, a bromide, an iodide, a chlorate, a bromate, an iodate, a polyoxymetalates, or a combination thereof. Suitable methods for inserting and substituting species into pore(s) and/or cage structure(s) of inorganic particles are known to those of ordinary skill in the art.

In some embodiments, the functional material is at least 50 wt. % (e.g., at least 60 wt. %, at least 70 wt. %, at least 80 wt. % of the separator, at least 90 wt. %, or at least 95 wt. %) of a separator. The functional material may be crystalline, amorphous, or a combination thereof. The functional material may be disposed in multiple discrete structures (e.g., particles). Accordingly, the functional material may have an average size (D₅₀) (e.g., particle size) in a range of 100 nm-30 μm. Also accordingly, the functional material may have, additionally or alternatively, a shape of spheres, rods, needles, flakes, platelets, cubes, discs, or tubes.

In some embodiments, in addition to a functional material, a separator includes one or more binders. The one or more binders may be no more than 50 wt. %, preferably no more than 20 wt. % of the separator. In some embodiments, the one or more binders are no more than 50 wt. % (e.g., no more than 40 wt. %, no more than 30 wt. %, no more than 20 wt. %, no more than 10 wt. %, no more than 5 wt. %, or no more than 1 wt. %) of the separator. The one or more binders may include polyvinylidene fluoride (PVDF), polytetrafluoroethylene (PTFE), polyvinyl alcohol, polyvinylpyrrolidone (PVP), polyacrylic acid (PAA), polyurethane (PU), polyvinyl acetate, polyvinyl chloride (PVC), carboxymethyl cellulose (CMC), hydroxypropyl cellulose (HPC), hydroxyethyl cellulose (HEC), styrene butadiene rubber (SBR) or a combination thereof. Optionally, a binder may include one or more additives. pH adjusters, pH buffers, rheological modifiers, de-foamers, anti-foamers, adhesion promoters, and leveling agents may be used as additives. In some embodiments, a separator may also include a conductive polymer, for example in addition to one or more binders (and a functional material). In some embodiments, the conductive polymer is no more than 80 wt. %, preferably no more than 50 wt. %, of the separator. A separator may include one or more of the following conductive polymers: polyaniline, polyacetylene, polyphenylene vinylene, polypyrrole, polythiophene, polyphenylene sulfide, polyfluorenes, polypyrenes, polyazulenes, polynapthalenes, poly(p-phenylene vinylene), poly(p-phenylene sulfide), PEDOT.

A separator including a functional material may be coated ex situ directly on to one or more electrodes (e.g., an anode or a cathode or both an anode and a cathode). The coating technique can include, but is not limited to, one or more or a combination of wet chemical reaction, physical vapor deposition, chemical vapor deposition, atomic layer deposition, sintering, pressing, hot pressing, extrusion, die casting, slot-die coating, and doctor-blade coating. When a separator is coated using one or more liquid coating methods, the coating(s) may be prepared using any manner of mixing known to those familiar to the art. The coating(s) may be water-borne or solvent-borne, including a functional material and one or more binders. A wet coated layer may be disposed onto an electrode with a thickness in a range of from 5 μm to 500 μm. The coated layer may be dried in air at any temperature in the range of 25° C. to 200° C. The coated layer may be further subjected to calendaring to increase adhesive strength or layer uniformity or both. A temperature treatment such as annealing may also be employed. Further, a separator may or may not be used in conjunction with a liquid electrolyte (e.g., may be used with a solid electrolyte).

A separator comprising a functional material may also be prepared via dip coating of an electrode into a coating formulation containing the functional material (e.g., in particle form). When the separator is coated using a dip coating method, the coating may be prepared using any manner of mixing known to those familiar to the art. The coating may be water-borne or solvent-borne, including a functional material and one or more binders.

In certain embodiments, a separator that comprises a functional material may be disposed on the surface of an electrode via in situ synthesis. In one example, this can be done via crystallization of a mixture of chemical precursors on an electrode (e.g., anode) surface. A crystallization reaction of the chemical precursors at 30-250° C. for 0-30 days, statically or under stirring conditions, can be used. The chemical precursors may include one or more of the following components: one a silica source, an alumina source, a mineralizing agent, acid or basic media, one or more templating agents or structure directing agents (SDAs).

In some embodiments, a separator may be prepared as a free-standing film. The free-standing film may be prepared in any number of ways. In one example, a free-standing film may be prepared by coating an inorganic particle separator onto a release layer which is then dissolved. The release layer may then be dissolved in an appropriate solvent. A free-standing film may also be produced by extruding a film that contains the functional material and one or more binders (e.g., binding polymers). The one or more binders may include a binding polymer, such as polyethylene, polyvinyl chloride, polycarbonate, acrylonitrile butadiene styrene, polyvinylidene fluoride (PVDF), polytetrafluoroethylene (PTFE), polyvinyl alcohol, polyvinylpyrrolidone (PVP), polyacrylic acid (PAA), polyurethane (PU), polyvinyl acetate, polyvinyl chloride (PVC), carboxymethyl cellulose (CMC), hydroxypropyl cellulose (HPC), hydroxyethyl cellulose (HEC), or styrene butadiene rubber (SBR), or a combination thereof.

In some embodiments, a separator comprising a functional material and one or more binders may be used in conjunction with a second separator, for example a second separator comprising a functional material and one or more binders, for example in an energy storage device such as a battery. The second separator may be placed in between two electrodes (e.g., an anode or a cathode), for example on an anode side of the first separator or the cathode side of the first separator, or both. Alternatively, the first separator may be disposed onto one or both sides of the second separator; the second separator may then be disposed between two electrodes.

Energy Storage Devices Including Materials, Separators, and/or Additives Disclosed Herein

An energy storage device may include a separator as disclosed herein, an additive disclosed herein (e.g., included in an electrode), or both. An energy storage device may be or include an electrochemical cell (e.g., half-cell). The energy storage device may be, for example, a battery, a fuel cell, or a capacitor. The battery may be a primary battery or a secondary battery. Independently of whether it is primary or secondary, the battery may be an aqueous battery or a non-aqueous battery (e.g., that includes a solid-state electrolyte). The battery may be an ion battery, such as an aluminum-ion, a sodium-ion battery, a potassium-ion battery, a proton battery, a calcium-ion battery, a manganese-ion battery, a lithium-ion battery, an air battery, or a combination of one or more, for example. The energy storage device does not need to have a specific cell construction, cathode composition, anode composition, electrolyte composition, or composition of any other electrode. The following are illustrative, but non-limiting, examples of energy storage devices in which use of a material, a separator, an additive, or a combination thereof disclosed herein is contemplated.

In some embodiments, a separator disclosed herein (e.g., including inorganic particles, one or more organic ligands, and/or partially reduced carbon (e.g., graphite or graphene)) is used in an electrochemical cell (e.g., battery). Such a separator may include inorganic particles as disclosed herein. In some embodiments, a separator disclosed herein is used in an electrochemical cell as an ion conductive material disposed between two electrodes (e.g., an anode and a cathode). In some embodiments, using a separator disclosed herein in an electrochemical cell increases electrolyte wettability. In some embodiments, a separator disclosed herein is used in a capacitor, for example as an ion conductive material disposed between two electrodes and/or to increase electrolyte wettability. In some embodiments, a separator disclosed herein is used in a fuel cell.

In some embodiments, an energy storage device includes a cathode, an anode, an electrolyte and a separator disclosed herein. The separator is disposed between the anode and the cathode thereby preventing direct physical contact of the cathode and the anode. The cathode, the anode or both may include an additive as disclosed herein (e.g., a different additive in the anode and in the cathode). In some embodiments, an energy storage device includes a cathode, an anode, an electrolyte, and a separator, where the anode, the cathode, or both, include an additive as disclosed herein. Use of a separator disclosed herein enables high energy density, extended cell life, and stability, one or more of which may be realized in an energy storage device that includes such a separator. A separator as disclosed herein could be made to be very thin, for example less than 100 micron, less than 50 micron, or less than 25 micron.

Inorganic particles described herein may have ion conducting properties. In some embodiments, an inorganic particle separator is capable of trapping gas that is generated from one or more undesirable side reactions in pores and/or cage structures resulting from the inorganic particles. In some embodiments, an inorganic particle separator provides protection from one or more undesired side reactions, including, but not limited to, irreversible surface reactions, loss of active material mass, corrosion, embrittlement, pulverization, and passivation of the surface of the electrodes. In some embodiments, inorganic particles can also provide a scaffold for byproducts of one or more electrochemical reactions that occur inside an energy storage device (e.g., electrochemical cell), thereby extending useable device life (e.g., cell life).

A separator disclosed herein may be used with an electrode (e.g., cathode or anode) that comprises an electroactive material that is an oxide, a suboxide, a sulfide, an oxysulfide, a phosphate, a phosphide and a carbide, or an elemental form of: silicon, vanadium, niobium, molybdenum, rhenium, tantalum, tungsten, bismuth, titanium, tin, antimony, manganese, nickel, aluminum, lithium, sodium, potassium, calcium, zinc, cobalt, chromium, indium, lanthanum, cerium, strontium, iron, a combination thereof. The electroactive material may be modified (e.g., doped) using one or more elements, including hydrogen, lithium, boron, carbon, nitrogen, oxygen, sulfur, sodium, magnesium, aluminum, silicon, potassium, calcium, titanium, vanadium, chromium, manganese, iron, cobalt, nickel, copper, zinc, gallium, germanium, rubidium, strontium, zirconium, niobium, molybdenum, ruthenium, silver, cadmium, indium, tin, antimony, lanthanum, cerium, neodymium, tantalum, tungsten, rhenium, platinum, gold, lead, bismuth, a combination thereof. An electrode including the electroactive material may be freestanding or may be present on a substrate (e.g., a current collector). (An electrode may be said to be disposed on a current collector or the electrode may be considered to include the current collector.) The substrate may include, but is not limited to, carbon materials such as foams, papers, aerogels, foils, fibers, or nanostructures (e.g., nanoparticles, nanorods, nanopillars), or metal foils, foams, sheets, meshes, or stock.

An electroactive material used in electrode in combination with a separator disclosed herein may be further modified (e.g., doped) with one or more elements. Without wishing to be bound by any particular theory, further modification (e.g., doping) can change conductivity, chemical reactivity, and/or electrochemical reactivity of the electroactive material. In some embodiments, when doped, an elemental dopant replaces less than 50 wt. % of the metal of an electroactive material, preferably less than 20 wt. % of the metal of the electroactive material. In some embodiments, the one or more elements are less than 50 wt. % (e.g., no more than 40 wt. %, no more than 30 wt. %, no more than 20 wt. %, no more than 10 wt. %, no more than 5 wt. %, or no more than 1 wt. %) of an electroactive material. The one or more elements (e.g., dopants) may be selected from: carbon, boron, nitrogen, iodine, phosphorous, antimony, indium, arsenic, gallium, tungsten, cadmium, and tellurium.

An energy storage device may include an anode. The anode may be modified by a milling process. A milling process may be used to reduce or broaden a particle size distribution (e.g., of additive particles in an electrode, such as an anode). Additionally or alternatively, a milling process may be used to alloy or chemically implant one or more conductive additives. Example of such additives include carbon, metal grit, and metal flakes. The carbon may be in the form of carbon black, acetylene black, carbon fibers, carbon nanotubes, graphene, graphite, fullerenes, or carbon aerogels. Useable milling processes include, but are not limited to, horizontal ball milling, vertical stirred agitator mills, planetary ball milling, and jet milling.

In some embodiments, an electrode for an energy storage device includes one more binders. Each of the one or more binders may be, for example, polyvinylidene fluoride (PVDF), polytetrafluoroethylene (PTFE), polyvinyl alcohol, polyvinylpyrrolidone (PVP), polyvinyl acetate, polyacrylic acid (PAA), polyvinyl chloride (PVC), carboxymethyl cellulose (CMC), hydroxypropyl cellulose (HPC), hydroxyethyl cellulose (HEC), styrene butadiene rubber (SBR), or a copolymer thereof. In some embodiments, an electrode for an energy storage device includes one or more conductive additives. Each of the one or more conductive additives may be selected from the following: carbon black, acetylene black, carbon fibers, carbon nanotubes, graphene, graphite, fullerenes, carbon aerogels, metal flakes, metal fibers, metal particles, and conductive polymers. A conductive polymer used in an electrode in an energy storage device may be, for example, polyaniline, polyacetylene, polyphenylene vinylene, polypyrrole, polythiophene, polyphenylene sulfide, polyfluorenes, polypyrenes, polyazulenes, polynapthalenes, poly(p-phenylene vinylene), poly(p-phenylene sulfide), or PEDOT.

In some embodiments, a separator may be used with an electrode that includes a conductive substrate. The substrate may include one or more carbon materials such as foams, papers, aerogels, foils, fibers, particles, conductive polymers, nanostructures, or metal foils, foams, sheets, meshes, or stock or a combination thereof. The substrate may include a conductive film applied to a physical support. The physical support may include one or more carbon materials such as foams, papers, aerogels, foils, fibers, or nanostructures, or metal foils, foams, sheets, meshes, or stock. The physical support may, alternatively or additionally, include one or more polymeric materials, such as, for example, polyvinylidene fluoride (PVDF), polytetrafluoroethylene (PTFE), polyvinyl alcohol, polyvinylpyrrolidone (PVP), polyvinyl acetate, polyvinyl chloride (PVC), carboxymethyl cellulose (CMC), hydroxypropyl cellulose (HPC), hydroxyethyl cellulose (HEC), styrene butadiene rubber (SBR), polyaniline (PANI), polypyrrole (PPyr), polystyrene (PS), polythiophene (PT), or copolymers thereof.

Polymer(s) used in an electrode (e.g., anode or cathode) may be incorporated into the electrode during the synthesis or assembly of the electrode, they may be chemically or electrochemically deposited onto the electrode during cycling, or they may be incorporated through some combination thereof.

An electrode substrate (e.g., current collector) may include active or inert materials. These potential materials include metals, oxides, suboxides, hydroxides, oxide hydroxides, oxychlorides, sulfides, oxysulfides, oxynitrates, carbonates, nitrides, phosphates, phosphites, carbides, and polymers, containing one or more of: hydrogen, lithium, boron, carbon, nitrogen, oxygen, sulfur, sodium, magnesium, aluminum, silicon, potassium, calcium, titanium, vanadium, chromium, manganese, iron, cobalt, nickel, copper, zinc, gallium, germanium, rubidium, strontium, zirconium, niobium, molybdenum, ruthenium, silver, cadmium, indium, tin, lanthanum, cerium, neodymium, tantalum, tungsten, rhenium, platinum, gold, lead, and bismuth. Additionally, the materials may also include inorganic particles described herein. The physical form of these materials may include, but is not limited to, flakes, pellets, powders, particles, tubes, cubes, or fibers.

In certain embodiments, an energy storage device includes a separator disclosed herein that is immersed or otherwise surrounded by an electrolyte (e.g., electrolytic solution).

In certain embodiments, an electrolyte is a solid-state electrolyte. In certain embodiments, an electrolyte is a solid polymer electrolyte. In certain embodiments, the solid polymer electrolyte comprises one or more polymers selected from the group consisting of (i) polymers that comprise repeat units of one or more of an ethylene oxide, a propylene oxide, analizarin, an alginate, a quinones, a hydroxyquinones, a hydroxyquinoline, silicon, a silicate, and asulfone, (ii) cellulosic, natural or modified natural polymers, and (iii) synthetic fluorinated polymers (e.g., polyvinylidene fluoride (PVDF) and polytetrafluoroethylene (PTFE)).

In certain embodiments, an electrolyte comprises one or more materials each having a stoichiometry of M1¹⁺ₓN1ₚ or M1²⁺ₓN1ₚ or M1³⁺ₓN1ₚ or M1⁴⁺ₓN1ₚ or M1¹⁺ₓN1ₚN2_{q} or M1²⁺ₓN1ₚN2_{q} or M1³⁺ₓN1ₚN2_{q} or M1⁴⁺ₓN1ₚN2_{q} or M1¹⁺ₓM2²⁺_{y}N1ₚ or M1¹⁺ₓM2³⁺_{y}N1ₚ or M1¹⁺ₓM2⁴⁺_{y}N1ₚ or M1²⁺ₓM2³⁺_{y}N1ₚ or M1²⁺ₓM2⁴⁺_{y}N1ₚ or M1³⁺ₓM2⁴⁺_{y}N1ₚ or M1¹⁺ₓM2²⁺_{y}N1ₚN2_{q} or M1¹⁺ₓM2³⁺_{y}N1ₚN2_{q} or M1¹⁺ₓM2⁴⁺_{y}N1ₚN2_{q} or M1²⁺ₓM2³⁺_{y}N1ₚN2_{q} or M1²⁺ₓM2⁴⁺_{y}N1ₚN2_{q} or M1³⁺ₓM2⁴⁺_{y}N1ₚN2_{q} or M1¹⁺ₓM2²⁺_{y}M3³⁺_{z}N1ₚ or M1¹⁺ₓM2²⁺_{y}M3⁴⁺_{z}N1ₚ or M1²⁺ₓM2³⁺_{y}M3⁴⁺_{z}N1ₚ or M1¹⁺ₓM2²⁺_{y}M3³⁺_{z}N1ₚN2_{q} or M1¹⁺ₓM2²⁺_{y}M3⁴⁺_{z}N1ₚN2_{q} or M1²⁺ₓM2³⁺_{y}M3⁴⁺_{z}N1ₚN2_{q} or M1¹⁺ₓM2²⁺_{y}M3³⁺_{z}M4⁴⁺ₛN1ₚ or M1¹⁺ₓM2²⁺_{y}M3³⁺_{z}M4⁴⁺ₛN1ₚ N2_{q}, wherein each M (e.g., M1, M2, M3, M4) is a monovalent or multivalent atom and each N (e.g., N1, N2) is a functional group (e.g., selected from the group consisting of a hydroxide, an alkoxide, a peroxide, a superoxide, a nitrate, a nitrite, a sulfate, a sulfite, a sulfide, a carbonate, a phosphate, a phosphate, a phosphide and a halide). In certain embodiments, the one or more materials comprised in the electrolyte form an ion conducting matrix.

In certain embodiments, an electrolyte comprises (e.g., further comprises) one or more of a salt, an acid and a base. In certain embodiments, the electrolyte: (i) comprises the salt, wherein the salt is selected from the group consisting of oxide, hydroxide, alkoxide, peroxide, superoxide, nitrate, nitrite, sulfate, sulfite, sulfide, carbonate, carbide, phosphate, phosphate, phosphide and halide salts of one or more of sodium, potassium, calcium, barium, cesium, scandium, cadmium, magnesium, iron, manganese, lithium, zinc, zirconium, niobium, yttrium, molybdenum, hafnium, osmium, nickel, cobalt, germanium, beryllium, mercury, tungsten, platinum, rubidium, ruthenium, rhodium, palladium, antimony, tellurium, bismuth, arsenic, lead, lanthanum, europium, gadolinium, cerium, tin, chromium, vanadium, titanium, aluminum, tantalum, gallium, indium, silver, gold, and copper; (ii) comprises the acid, wherein the acid is selected from the group consisting of phosphoric acid, nitric acid, sulfuric acid, hydrochloric acid, sulfurous acid, triflic acid, hydrofluoric acid, peracetic acid, boric acid, uric acid, citric acid, hydroiodic acid, carbonic acid, oxalic acid, bromic acid, chromic acid, formic acid, ascorbic acid, and acetic acid; (iii) comprises the base, wherein the base is selected from the group consisting of hydroxides of sodium, potassium, calcium, magnesium, manganese, lithium, zinc, zirconium, cerium, tin, titanium, aluminum, ammonium, iron, indium, molybdenum, nickel, platinum, palladium, ruthenium, silver, vanadium, and copper; or (iv) any combination of (i), (ii), and (iii).

In certain embodiments, an electrolyte comprises one or more ceramics selected from the group consisting of aluminum oxide, ammonium antimony tungsten oxide, barium titanate, strontium titanate, bismuth strontium calcium copper oxide, boron oxide, boron nitride, ferrites, lead zirconate titanate, magnesium diboride, porcelain, sialon, silicon, silicates, carbide, nitride, titanium carbide, uranium oxide, yttrium barium copper oxide, zinc oxide, cesium oxide, cerium oxide, zirconium oxide, vanadium oxide, tin oxide, iron oxide, tungsten chloride oxide, beryllium oxide, bismuth oxide, lithium oxide, lead oxide, manganese oxide, magnesium oxide, nickel oxide, titanium oxide, cadmium oxide, copper oxide, indium oxide, and silicon oxide. In certain embodiments, an electrolyte further comprises water molecules disposed in a crystal structure (e.g., water of hydration).

In certain embodiments, an electrolyte is a free-standing film or has been applied to a separator, to an anode, to a cathode, or to a combination thereof.

An energy storage device that includes a separator disclosed herein, an additive disclosed herein, or both, may be an electrochemical cell, such as a battery, that has any one or more of a variety of form factors. For example, the electrochemical cell may be a pouch cell, a coin cell, a cylindrical cell, or a prismatic cell.

Certain embodiments of the present disclosure were described above. It is, however, expressly noted that the present disclosure is not limited to those embodiments, but rather the intention is that additions and modifications to what was expressly described in the present disclosure are also included within the scope of the disclosure. Moreover, it is to be understood that the features of the various embodiments described in the present disclosure were not mutually exclusive and can exist in various combinations and permutations, even if such combinations or permutations were not made express, without departing from the spirit and scope of the disclosure. The disclosure has been described in detail with particular reference to certain embodiments thereof, but it will be understood that variations and modifications can be effected within the spirit and scope of the claimed invention.

1. A separator for an energy storage device, the separator comprising inorganic particles.

2. The separator of claim 1, comprising one or more binders, wherein the one or more binders bind together the inorganic particles.

3. The separator of claim 1, wherein the inorganic particles are functional inorganic particles.

4. (canceled)

5. The separator of claim 1, wherein the inorganic particles are at least 50 wt. % of the separator.

6. The separator of claim 1, wherein the inorganic particles comprise one or more elements selected from the group consisting of oxygen, hydrogen, sulfur, aluminum, silicon, and phosphorous.

7. The separator of claim 1, wherein the inorganic particle comprise one or more metal atoms.

8. The separator of claim 7, wherein the one or more metal atoms are selected from the group consisting of aluminum, silicon, lithium, sodium, potassium, rubidium, cesium, beryllium, magnesium, calcium, strontium, barium, boron, gallium, indium, thallium, carbon, germanium, tin, lead, nitrogen, phosphorous, arsenic, antimony, bismuth, scandium, titanium, vanadium, chromium, manganese, iron, cobalt, nickel, copper, zinc, yttrium, zirconium, niobium, molybdenum, ruthenium, rhodium, palladium, silver, cadmium, hafnium, tantalum, tungsten, rhenium, osmium, iridium, platinum, gold, mercury, lanthanum, cerium, praseodymium, neodymium, samarium, europium, gadolinium, terbium, dysprosium, holmium, erbium, thulium, ytterbium, lutetium, actinium, thorium, protactinium, uranium, neptunium, and plutonium.

9. (canceled)

10. The separator of claim 1, wherein the inorganic particles are porous and have microporosity, mesoporosity, macroporosity, or a combination thereof.

11-13. (canceled)

14. The separator of claim 1, wherein each of the inorganic particles is porous and comprises one or more pores having a size in a range of from 1 Å to 20 Å.

15. The separator of claim 1, wherein each of the inorganic particles is porous and comprises one or more pores that connect to form at least one channel through the inorganic particle.

16. The separator of claim 15, wherein the at least one channel for each of the inorganic particles are connected to form a channel system.

17. The separator of claim 16, wherein the channel system is a 1-dimensional, 2-dimensional, or 3-dimensional channel system.

18. The separator of claim 16, wherein the channel system extends throughout the separator.

19. The separator of claim 1, wherein the inorganic particles are porous and comprise one or more cage structures.

20. The separator of claim 19, wherein at least one of the one or more cage structures is disposed at an intersection of pores of the inorganic particles.

21. The separator of claim 19, wherein each of the one or more cage structures has a size in a range of from 1 Å to 20 Å.

22. The separator of claim 19, wherein at least one of the one or more cage structures is disposed in a 1-dimensional pore.

23. The separator of claim 19, wherein one or more species are disposed in the one or more cage structures.

24. The separator of claim 1, wherein one or more species are disposed in one or more pores of the inorganic particles.

25. The separator of claim 23, wherein the one or more species comprise a member selected from the group consisting of olefinic hydrocarbons, paraffinic hydrocarbons, naphthenic hydrocarbons, and aromatic hydrocarbons.

26. The separator of claim 23, wherein the one or more species comprise water.

27-239. (canceled)
